(19) United States
(12) Patent Application Publication
(10) Pub. No.: US 2025/0340083 A1
(43) Pub. Date: Nov. 6, 2025

(54) Magnetic support for pens and the like

(71) Applicant: Terrence Saucier, Cattaraugus, NY (US)

(72) Inventor: Terrence Saucier, Cattaraugus, NY (US)

(21) Appl. No.: 18/653,862

(22) Filed: May 2, 2024

(51) Int. Cl. B43M 99/00; F16M 11/04; H01F 7/02

(52) U.S. Cl. CPC B43M 99/004; F16M 11/041; H01F 7/0252

(57) ABSTRACT

A magnetically balanced pen and base set which includes a base member housing a small magnet and a larger magnet located directly below it. The pen assembly has a barrel, a magnetically attractable tip, and a small, but powerful magnet located inside the barrel above the tip. The magnet in the pen barrel has a polarity equal to that of the upper surface of the large magnet in the base. these two magnets repel each other holding the pen up, while the smaller magnet holds the tip of the pen to the base.

### CROSS REFERENCE TO RELATED APPLICATION

This patent application is related to and claims priority from U.S. Provisional Patent Application Ser. No. 63/463,560 filed May 2, 2023

### FIELD OF THE INVENTION

The present disclosure relates, in general, to magnetic pen holder sets, more particularly, this disclosure relates to an apparatus that appears to make pens and the like appear to stand in defiance of gravity.

### BACKGROUND OF THE INVENTION

People use magnetic support devices to hold pens, and such. However, there are problems with existing magnetic support devices. Accordingly, there is a need in the art for an improved magnetic support device.

In the world of magnetic pen holder sets, and other similar devices, the market is saturated with devices that follow the same basic arrangement. This arrangement usually consists of a pen, or object, and a base member. The user is required to insert the pen, or object in to a cavity, or in to a cradle like structure that partially rises up along the sides of the object, and surrounds, or partially surrounds a good portion of the pen.

Once the pen, or object has been placed within the cavity, or cradle structure, and the tip makes contact with a resting point within the bottom of the cavity, or within the surrounding cradle, it can then be released, and magnetic forces will hold the pen, or object in place, and support it. It will remain balanced, and only the tip remains in physical contact with the base. While this arrangement works, it both looks, and feels obtrusive to the user.

This arrangement can be found in several designs. The most notable variation is usually the angle at which the pen is supported relative to the horizon. Some variations of this arrangement place the supporting magnets directly under, and substantially adjacent to the the barrel of the pen, or body of the object being supported. Although this functions well, it is still quite limiting when it comes to design, and somewhat unimpressive as the detachable object is almost hugging the support fixture directly below it.

An alternative approach has been disclosed, but limits the placement of the pen to a central point on a relatively broad horizontal plane, and is highly susceptible to external interference which can drastically alter, or completely brake the functionality of the device.

Several magnetically supported pens, and similar devices have been disclosed in the prior art. Spatz in U.S. Pat. No. 2,693,788 disclosed a magnetic desk pen set wherein the top tip of the pen is engaged in a recess in one end of a base. The other end of the base has magnets arranged to repel a magnetic element inside the pen such that the writing end of the pen is levitating within a cradle of the base. Thus, the pen is substantially in a prone position with the writing tip pointed slightly upward.

In U.S. Pat. No. 4,643,604, Enrico discloses a magnetic pen holder wherein a permanent magnet is positioned within the pen a short distance from the tip. The pen is then lodged within a cavity in a base member which has magnets oriented to attract the magnet housed in the pen. In this Enrico patent, the pen can only be positioned straight up, and because of the cavity, it appears to be very similar to a holder where the pen is held just by friction. The same two drawbacks apply to the magnetic pen holder shown in U.S. Design Pat. No. D510,954.

In US Pat. No. 20,030,176,144, OneWorld Enterprises Ltd discloses a magnetic holder set in which a broad variety of objects may be suspended by means of repelling sets of magnets in the base, and suspended object. The magnetic forces employed hold aloft the removable object while shunting it in one direction. A vertical barrier is employed to hold the suspended object in place, and keep it from being ejected from the base. The object is suspended substantially close to the top surface of a relatively large base with the repelling magnets in the base, and object in close proximity to one another.

In US Pat. No. 20,090,035,050, Ramos discloses a magnetic holder set wherein a pen, and some other objects are magnetically balanced on, and in the center of a broad, and flat base member by means of a concentric set of magnets in the base member. One of these magnets interacts repulsively with a magnet in the pen, while the pens magnetically attractive tip is held in place on the top surface of the base by the other magnet. The pen can stand straight up, or at an angle. There are also embodiments disclosed in which this arrangement is inverted, and the concentric magnet set is located in a relatively broad, and flat detachable object.

In CN Pat. No. 202,011,333,073, Shanghai Zhiheng Business Consulting Co ltd discloses a magnetic cradle and pen in which a pen stands vertically by means of repelling magnetic forces generated between a permanent magnet within the barrel of the pen, and a plurality of magnets rising up from the top of the base along side, and surrounding the barrel of the pen.

In TW Pat. No. 202,011,333,073, Liang Guohong discloses a magnetic cradle and pen in which a pen stands at an angle relative to the horizon by means of repelling magnetic forces generated between a permanent magnet within the barrel of the pen, and a plurality of magnets rising up from the top of the base along side, and surrounding the barrel of the pen.

In US Pat. No. 20,230,094,251, Novium Taiwan Inc discloses a magnetic cradle and pen in which a pen rests at an angle relative to the horizon by means of repelling magnetic forces generated between a permanent magnet within the barrel of the pen, and a plurality of magnets in the base running parallel along side, and substantially adjacent to the barrel of the pen. A number of embodiments set at a variety of angles are provided.

In TW Pat. No. 1813519, Liang Guohong, and Guo Mingwei disclose a base, and knife set in which a crafting knife is balanced on its blade on, and at an acute angle to the top surface of the base. The blade is held to the base by means of an embedded magnet. The handle portion of the knife is held aloft by means of repelling magnetic forces generated by magnets in the handle, and magnets concealed in the base which are directly under, and substantially adjacent to the magnets in the handle

In JP Pat. No. 2,009,007,015 Kuniyasu Honda discloses a pen and base with a unique ball and socket joint. The ball portion of the joint is attached to the pen as a cap would be, and is detachable from the socket portion of the joint which is affixed to the base member. The socket contains magnets which provide a holding force to secure the ball portion of the joint. The base may be affixed to horizontal, or vertical surface, and the joint may be articulated at nearly any angle.

### SUMMARY OF THE INVENTION

The present disclosure provides a magnetically self balancing pen and base set including a base member, and a pen, or similar detachable object. There are two sets of magnetic members which provide the forces necessary to both anchor the detachable object to the base, and to repel the body of the detachable object away from the base so that it is both protracted away from the base, and lifted up against gravity.

One set of magnets is referred to as the repelling magnetic members and consists of at least one permanent magnet in the base, and at least one permanent magnet in the detachable object, and are arranged with like polls facing each other. The second set referred to as the magnetic anchoring units provides an attractive force to hold the detachable object to the base. At least one of the magnetic anchoring units must contain a permanent magnet, and the other may be a magnetically attractive material, or may be another permanent magnet, or any combination, or concatenation of magnets, and magnetically attractive materials, and may contain other materials to meet design needs. If each anchoring unit contains a permanent magnet, they must be arranged with opposite polls facing each other.

The magnets are uniquely arranged in this disclosure when compared to the prior art as will become apparent in the claims, and drawings. In a general order, and in a preferred embodiment, they are arranged in a linear manner as follows . . .
1. repelling magnetic member of base;
2. anchoring magnetic unit of base;
3. anchoring magnetic unit of detachable object;
4. repelling magnetic member of detachable object.

This is merely an example, and does not limit this disclosure to this simplified form.

This arrangement better separates both physically, and visually the detachable object from the bulk of the base. By placing the point of contact in between the repelling sets of magnets, the repelling magnets become less adjacent to one another, and thus creates a better illusion of weightlessness by obscuring the relationship between the repelling sets of magnets. This arrangement allows a vast range of possibilities for artistic expression not available in the prior art. An added benefit is that in all known cases, the look and feel of all prior art can be mimicked without violating the prior art making this disclosure a vastly superior improvement.

This disclosure additionally includes improvements over the prior art for negating interference caused by external objects such as steel top desks which can completely brake some of the functionality found in the prior art. These improvements have the added benefit of shaping magnetic fields, thus being able to strengthen magnets in a strategic way making them more economical.

### BRIEF DESCRIPTION OF THE DRAWINGS

NOTE: For simplicity of illustration, pins, joints, nuts, bolts, washers, sliding mechanisms, and minutiae of common industry hardware are not depicted as they are known to those with skill in the art. When they are shown, it is purely for illustrative purposes and not intended to capture all embodiments of the invention disclosed.

FIG. 1 is an elevation view of a partial cross section of a preferred embodiment of the present disclosure.

FIG. 2 is an elevation view of a partial cross section of an alternate preferred embodiment of the present disclosure featuring an annular magnet.

FIG. 3 is an elevation view of a partial cross section of an alternate preferred embodiment of the present disclosure featuring a plurality of repelling magnets.

FIG. 4 is an elevation view of a partial cross section view of a preferred embodiment of the present disclosure featuring an angled detachable member.

FIG. 5 is an elevation view of a partial cross section of a preferred embodiment of the present disclosure featuring an off center, and slightly rotated anchoring magnet with an angled detachable member disposed on base.

FIG. 6 is an elevation view of a partial cross section of a preferred embodiment of the present disclosure featuring a substantially offset, and substantially rotated anchoring magnet with an approximately horizontal detachable member disposed on base.

FIG. 7 is an elevation view of a partial cross section view of an alternate preferred embodiment of the present disclosure featuring a plurality of repelling magnets with polls rotated 90 degrees.

FIG. 8 is an elevation view of a partial cross section of an alternate preferred embodiment of the present disclosure featuring an annular magnet. The magnets are set at an angle to the horizon with an angled detachable members disposed on base.

FIG. 9 is an elevation view of a partial cross section of an alternate preferred embodiment of the present disclosure featuring an annular magnet. The magnets are set at an angle to the horizon with an angled detachable member disposed on base. The annular magnet is rotated to a slightly different angle than the other rotated members.

FIG. 10 is an elevation view of a partial cross section of an alternate preferred embodiment of the present disclosure featuring an annular magnet, and a detachable object disposed upon a domed top surface of the base member with up to about 5 mm of material separating the anchoring magnetic members.

FIG. 11 is an elevation view of a partial cross section of an alternate preferred embodiment of the present disclosure featuring an annular magnet, and an off center arrangement.

FIG. 12 is an elevation view of a partial cross section of an alternate preferred embodiment of the present disclosure featuring an annular magnet on a sliding mechanism.

FIG. 13 is an elevation view of a partial cross section of an alternate preferred embodiment of the present disclosure featuring an annular magnet and an anchoring magnet on a sliding mechanism.

FIG. 14 is an elevation view of a partial cross section of an alternate preferred embodiment of the present disclosure featuring an annular magnet and an anchoring magnet on a flexible, telescoping appendage posed with a detachable object standing vertical, and on center to the base, and is provided to demonstrate the versatility of the current disclosure.

FIG. 15 is related to FIG. 14 and is an elevation view of a partial cross section of an alternate preferred embodiment of the present disclosure featuring an annular magnet, and an anchoring magnet on a flexible, telescoping appendage posed with a detachable object standing at an angle, and off center to the base.

FIG. 16 is related to FIG. 14 and is an elevation view of a partial cross section of an alternate preferred embodiment of the present disclosure featuring an annular magnet and an anchoring magnet on a flexible, telescoping appendage posed with a detachable object resting approximately horizontally, and substantially off center from the base.

FIG. 17 is an elevated perspective view of a partial cross section of an alternate preferred embodiment of the present disclosure featuring an annular magnet, and attached to a stand with an articulating arm.

FIG. 18 is an elevated perspective view of a partial cross section of an alternate preferred embodiment of the present disclosure featuring an annular magnet, and having an adhesive backing for mounting to a vertical surface. A detachable object is disposed on center, and has a slight downward deflection due to gravity.

FIG. 19 is an elevated perspective view of a partial cross section of an alternate preferred embodiment of the present disclosure featuring an annular magnet on a sliding mechanism, and having an adhesive backing for mounting to a vertical surface. A detachable object is disposed on center, and is approximately horizontal due to asymmetrical magnetic force counteracting downward deflection caused by gravity.

FIG. 20 is an elevated perspective view of a an alternate preferred embodiment of the present disclosure featuring a semi-annular magnet, and having an adhesive backing for mounting to a vertical surface. A detachable object is disposed on center, and is approximately horizontal due to asymmetrical magnetic force counteracting downward deflection caused by gravity. The body of the base member has been omitted for clarity.

FIG. 21 is an elevation view of a partial cross section of a preferred embodiment of the present disclosure featuring an off center, and angled anchoring magnetic member of the base with an angled detachable member disposed on the base. The anchoring magnetic unit of the detachable member is disposed in the side wall.

FIG. 22 is an elevation view of a partial cross section of a preferred embodiment of the present disclosure featuring a flux guide.

FIG. 23 is an elevation view of a partial cross section of a preferred embodiment of the present disclosure featuring an annular magnet, and a flux guide.

FIG. 24 is an elevation view of a partial cross section of a preferred embodiment of the present disclosure featuring an annular magnet, and a flux guide with a detachable object disposed at an angle upon the base member.

FIG. 25 is an elevation view of a partial cross section of a preferred embodiment of the present disclosure featuring an annular magnet, and a flux guide with a detachable object disposed upon a base member having domed top surface.

FIG. 26 is an elevation view of a partial cross section of a preferred embodiment of the present disclosure featuring an annular magnet, and a flux guide with a detachable object disposed at an angle upon the base member.

FIG. 27 is an elevation view of a partial cross section of a preferred embodiment of the present disclosure featuring a single magnetic member in the base.

FIG. 28 is an elevated perspective view of a preferred embodiment of the present disclosure featuring a single magnetic member in the form of a horseshoe magnet. The body of the base has been omitted for clarity.

FIG. 29 is an elevated perspective view of a preferred embodiment of the present disclosure featuring a single magnetic member in the form of a horseshoe magnet. The body of the base has been omitted for clarity.

FIG. 30 is a profile view of a preferred embodiment of the present disclosure featuring a single magnetic member in the form of a horseshoe magnet composed of a concatenation of magnets, and ferromagnetic material. The body of the base has been omitted for clarity.

FIG. 31 is a profile view of a partial cross section of a preferred embodiment of the present disclosure featuring a single magnetic member in the base composed of a concatenation of magnets, and ferromagnetic material.

FIG. 32 is an elevation view of a partial cross section of a preferred embodiment of the present disclosure featuring a single magnetic member in the detachable member.

FIG. 33 is an elevation view of a partial cross section of a preferred embodiment of the present disclosure featuring a bisecting horizontal plane.

FIG. 34 is an elevation view of a partial cross section of a preferred embodiment of the present disclosure featuring a bisecting angled plane.

FIG. 35 is a front view of a an embodiment of the present disclosure featuring a bisecting horizontal plane. The body of the base has been omitted for clarity.

FIG. 36 is a front view of a an embodiment of the present disclosure featuring a bisecting vertical plane. The body of the base has been omitted for clarity.

FIG. 37 is a front view of a an embodiment of the present disclosure featuring a bisecting angled plane. The body of the base has been omitted for clarity.

FIG. 38 depicts a cylinder magnet in perspective, and the cylinder magnet in profile with magnetic lines of flux.

FIG. 39 depicts a cylinder magnet with an attached flux guide in perspective, and the cylinder magnet with attached flux guide in profile with magnetic lines of flux.

FIG. 40 depicts an annular magnet with a concentric cylinder magnet in perspective.

FIG. 41 depicts a partial cutaway of an annular magnet with a concentric cylinder magnet in profile.

FIG. 42 depicts a partial cutaway of an annular magnet with a concentric cylinder magnet in profile with magnetic lines of flux.

FIG. 43 depicts an annular magnet with a concentric cylinder magnet with an attached flux guide in perspective.

FIG. 44 depicts a partial cutaway of an annular magnet with a concentric cylinder magnet with an attached flux guide in profile.

FIG. 45 depicts a partial cutaway of an annular magnet with a concentric cylinder magnet with an attached flux guide in profile and with magnetic lines of flux.

FIG. 46 depicts an elevated perspective view of a cylinder magnet positioned above an annular magnet.

FIG. 47 depicts a profile view of a cylinder magnet positioned above a cutaway of a an annular magnet Several alternate positions of the cylinder magnet are drawn with broken lines.

FIG. 48 depicts an elevated perspective view of a small cylinder magnet positioned above a larger cylinder magnet.

FIG. 49 depicts a profile view of a small cylinder magnet positioned above a larger cylinder magnet. Several alternate positions of the small cylinder magnet are drawn with broken lines.

FIG. 50 depicts an elevated perspective view of a small cylinder magnet positioned above a plurality of larger cylinder magnets.

FIG. 51 depicts a profile view of a small cylinder magnet positioned above a plurality of larger cylinder magnets. Several alternate positions of the small cylinder magnet are drawn with broken lines.

FIG. 52 is a front view of a partial cross section of a preferred embodiment of the present disclosure. This embodiment represents an artistic base which is more viable as a finished product.

FIG. 53 is a front view of a stress ball balanced on the nose of a seal base member and is provided to demonstrate the versatility of the current disclosure.

FIG. 54 is a front view of a stress ball balanced on the nose of a seal base member and is related to FIG. 53. with internal magnetic members drawn with broken lines. Some details have been omitted for clarity.

FIG. 55 is related to FIG. 5 and is a simple line drawing of a pen balanced on an artistic base member, and is provided to demonstrate the versatility of the current disclosure.

FIG. 56 is a top down view of the pen, and base from FIG. 55.

FIG. 57 is a front view of a partial cutaway of the pen, and base from FIG. 55.

FIG. 58 is related to FIG. 6, and is a simple line drawing of a pen resting horizontally in mid air, and attached by a single point of contact to an artistic base member, and is provided to demonstrate the versatility of the current disclosure.

FIG. 59 depicts the pen, and base from FIG. 58 drawn in profile.

FIG. 60 is a top-down view of the pen, and base from FIG. 58.

FIG. 61 is a top-down view of the pen, and base from FIG. 58 and depicts a plurality of repelling magnets in the base member.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures. Provided below in an index of reference numbers found within the drawings and figures.
100 base member
101 body of base
102 first repelling magnetic member
103 first magnetic anchoring unit
104 rubber bushing
105 flexible oil tub
106 pop rivet
107 magnetic flux guide
108 poseable appendage
109 articulating arm
110 A single first magnetic member which replaces both first repelling magnetic member
102 and first
   magnetic anchoring unit 103.
111 slot A
112 slot B
120 adhesive backing
200 detachable member
201 body of detachable member
202 second magnetic anchoring unit
203 second repelling magnetic member
204 A single second magnetic member which replaces both second repelling magnetic member 203 and
   second magnetic anchoring unit 202.
222 a stand
300 a plane
400 a point of contact between base member and detachable object
500 magnetic lines of flux

Although it has already been stated in the summary, it should be noted that the magnetic anchoring units referred to in this disclosure may be magnetic dipoles, ferromagnetic materials, or any combination, or concatenation thereof, and may contain other materials to meet design needs. At least one of the magnetic anchoring units must contain a permanent magnet, and the other may be a magnetically attractive material, or may be another permanent magnet, or any combination of the two as stated above. If each anchoring unit contains a permanent magnet, they must be arranged with opposite polls facing each other.

It is also worth reiterating that for simplicity of illustration, pins, joints, nuts, bolts, washers, sliding mechanisms, and minutiae of common industry hardware are not depicted as they are known to those with skill in the art. When they are shown, it is purely for illustrative purposes and not intended to capture all embodiments of the present disclosure.

Materials such as resins, metals, plastics, composites, wood, stone, and the like, and construction methods such as sculpting, machining, casting, molding, various methods of additive manufacturing, and the like, as well as assembly methods for various embodiments are omitted as they are known to those with skill in the art, and are not central to this disclosure.

It should also be understood that in all embodiments wherein a magnetic dipole is used in the first anchoring magnetic unit 103, the north and south polls of the first repelling magnetic member 102, and the first anchoring magnetic unit 103 can face any direction relative to each other However, when both magnets are affixed to a flux guide 107, it should be assumed that the polls are facing in opposite directions unless stated otherwise.

As a final note, specific shapes for various components such as magnets may be mentioned in this disclosure. However, in most cases this is not intended to be a limiting factor. Any suitable shape, or alternative component may be substituted.

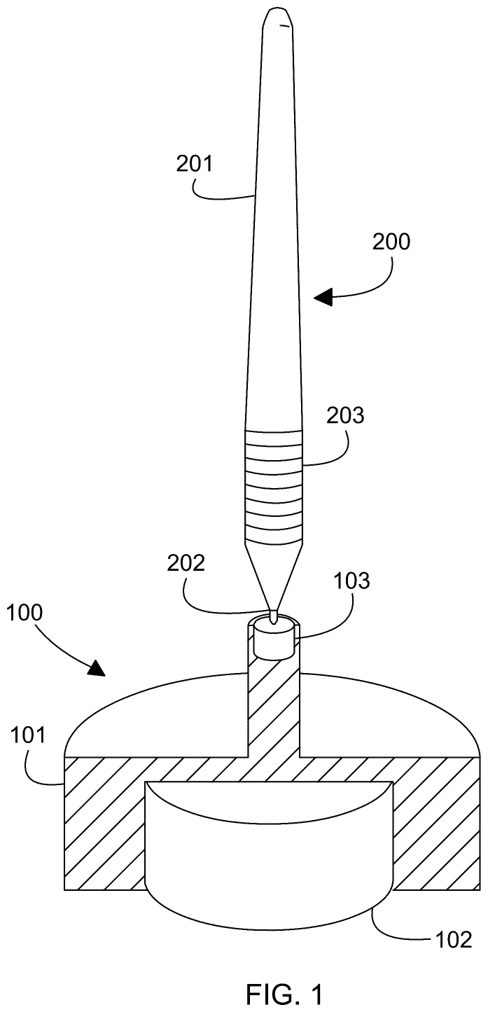

Disclosed herein is a magnetic support for pens, and the like. Referring initially to FIG. 1, an elevated view of a partial cutaway depicts a preferred embodiment featuring a magnetically balanced detachable member 200 which is disposed upon a base member 100. A strong cylindrical magnet, which is a first repelling magnetic member 102 is disposed within the body of the base 101. Centered directly above the first repelling magnetic member 102, is a first magnetic anchoring unit 103. A second magnetic anchoring unit 202 is disposed within the body of the detachable member 200, and is magnetically disposed upon the first magnetic anchoring unit 103. A second repelling magnetic member 203, which is drawn as a stack of magnets, is disposed within the body of the detachable member 201 above the second magnetic anchoring unit 202.

The first repelling magnetic member 102, and the second repelling magnetic member 203 are oriented with like polls facing each other so as to generate a repelling magnetic force strong enough to cause the detachable member 200 to protract away from the base member 100, and stand vertically against gravity. The first magnetic anchoring unit 103, and the second magnetic anchoring unit 202 provide a magnetic holding force strong enough to hold the detachable member 200 to the base member 100 against the repelling force while still allowing for easy removal, and placement.

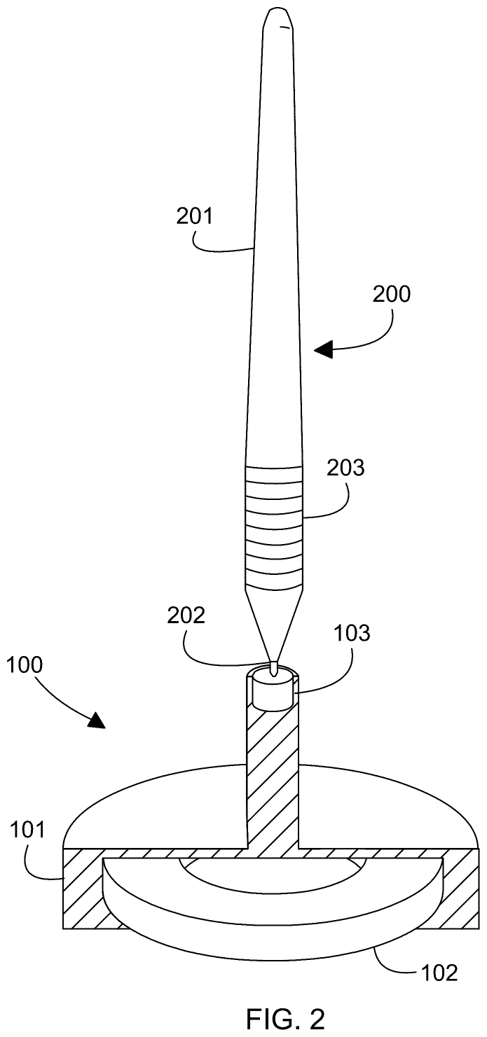

FIG. 2 presents an elevated view of a partial cutaway depicting an alternate preferred embodiment featuring a magnetically balanced detachable member 200 which is disposed upon a base member 100. A first repelling magnetic member 102, which is a strong annular magnet, is disposed within the body of the base 101. Centered directly above the first repelling magnetic member 102, is a first magnetic anchoring unit 103. A second magnetic anchoring unit 202 is disposed within the body of the detachable member 202, and is magnetically disposed upon the first magnetic anchoring unit 103. A second repelling magnetic member 203, which is drawn as a stack of magnets, is disposed within the body of the detachable member 201 above the second magnetic anchoring unit 202.

The first repelling magnetic member 102, and the second repelling magnetic member 203 are oriented with like polls facing each other so as to generate a repelling magnetic force strong enough to cause the detachable member 200 to protract away from the base member 100, and stand vertically against gravity. The first magnetic anchoring unit 103, and second magnetic anchoring unit 202 provide a magnetic holding force strong enough to hold the detachable member 200 to the base member 100 against the repelling force while still allowing for easy removal, and placement.

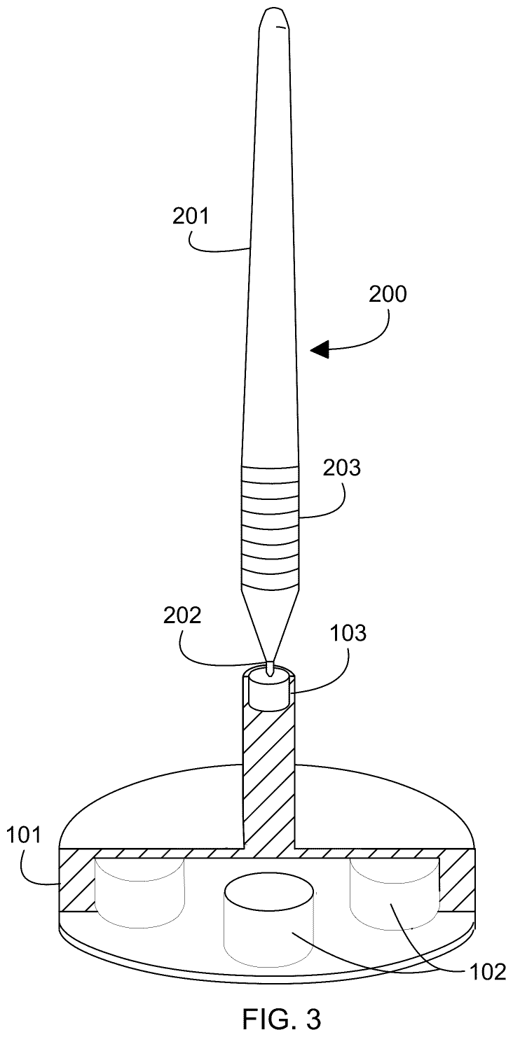

FIG. 3 presents an elevated view of a partial cutaway depicting an alternate preferred embodiment featuring a magnetically balanced detachable member 200 which is disposed upon a base member 100. A first repelling magnetic member 102, which in this embodiment is composed of a plurality of cylindrical magnets, is disposed within the body of the base 101. Centered directly above the first repelling magnetic member 102, is a first magnetic anchoring unit 103. A a second magnetic anchoring unit 202 is disposed within the body of the detachable member 200, and is magnetically disposed upon the first magnetic anchoring unit 103. A second repelling magnetic member 203, which is drawn as a stack of magnets, is disposed within the body of the detachable member 201 above the second magnetic anchoring unit 202. The first repelling magnetic member 102, and the second repelling magnetic member 203 are oriented with like polls facing each other so as to generate a repelling magnetic force strong enough to cause the detachable member 200 to protract away from the base member 100, and stand vertically against gravity. The first magnetic anchoring unit 103, and second magnetic anchoring unit 202 provide a magnetic holding force strong enough to hold the detachable member 200 to the base member 100 against the repelling force while still allowing for easy removal, and placement.

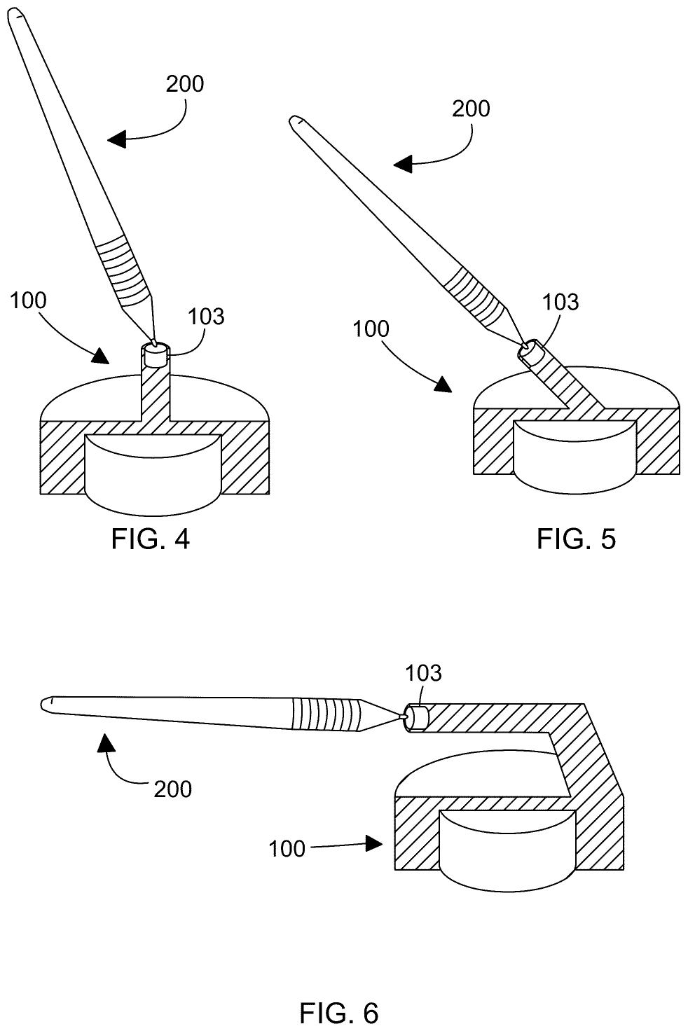

FIGS. 4,5 and 6 depict alternate preferred embodiments related to FIG. 1. Please refer back to FIG. 1, and the description provided if needed. Additionally, these embodiments depict features which represent a small subset of variations. These are only a small sampling across a vast spectrum of possibilities relating to the placement, orientation, and interactions of various components. Furthermore these variations may be combined with any other feature, or variation found within, or implied by this disclosure.

FIG. 4 depicts a variation of the embodiment found in FIG. 1 featuring a detachable member 200 which is disposed upon a base member 100 and is resting at a slight angle. This angle is controlled by the relationship between the weight of the detachable member 200, and the strength of the repelling magnetic force acting upon it. A first anchoring magnetic unit 103 is parallel to the horizon.

FIG. 5 depicts a variation of the embodiment found in FIG. 1 featuring a detachable member 200 which is disposed upon a base member 100 and is resting at a pronounced angle. This angle is controlled by the relationship between the weight of the detachable member 200, and the strength of the repelling magnetic force acting upon it, and in this embodiment, the angle is significantly influenced by an asymmetrical repelling magnetic force which will hold it at a preferred angle, and orientation protracting away form the base member 100. A first anchoring magnetic unit 103 is offset from the center of the base 100, and is set at an angle. This angle can serve two purposes. The first purpose is purely aesthetic. The second purpose is mechanical. By matching the protracted angle of the detachable member 200, sheering forces are minimized which lowers the risk of the detachable member 200 being ejected from the base member 100.

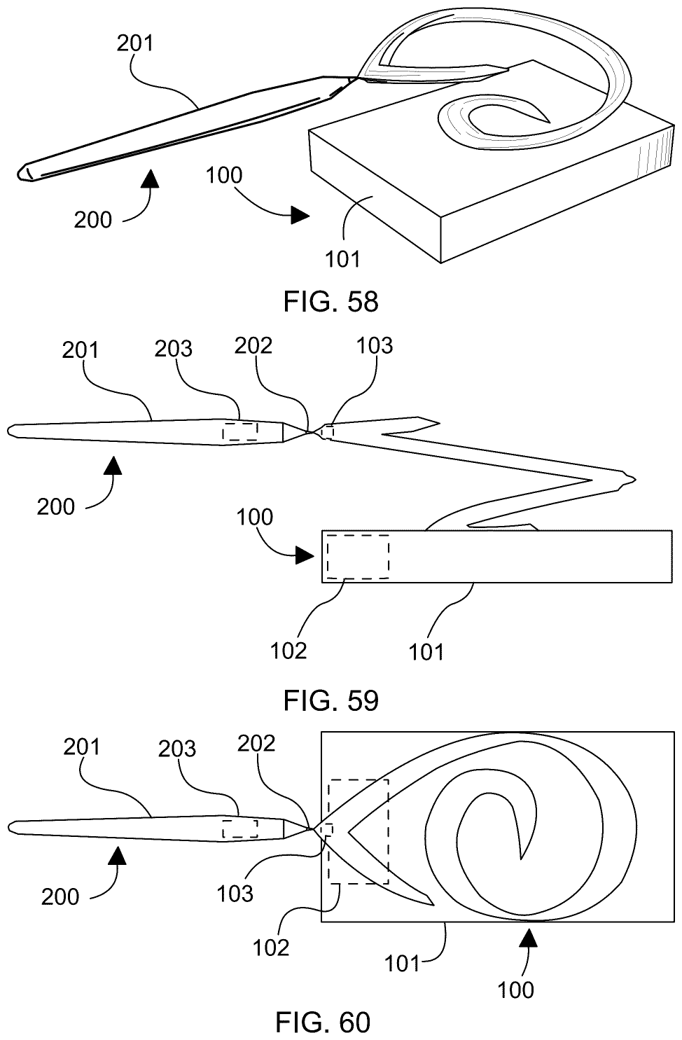

FIG. 6 follows the same basic logic, and functionality as FIG. 5, but with a much grater offset, and angle. The ability to hang the detachable object 200 horizontally over a void beyond the edge of the base member 100 is arguably the most profound function of this disclosure. A related embodiment is provided in FIGS. 58-61.

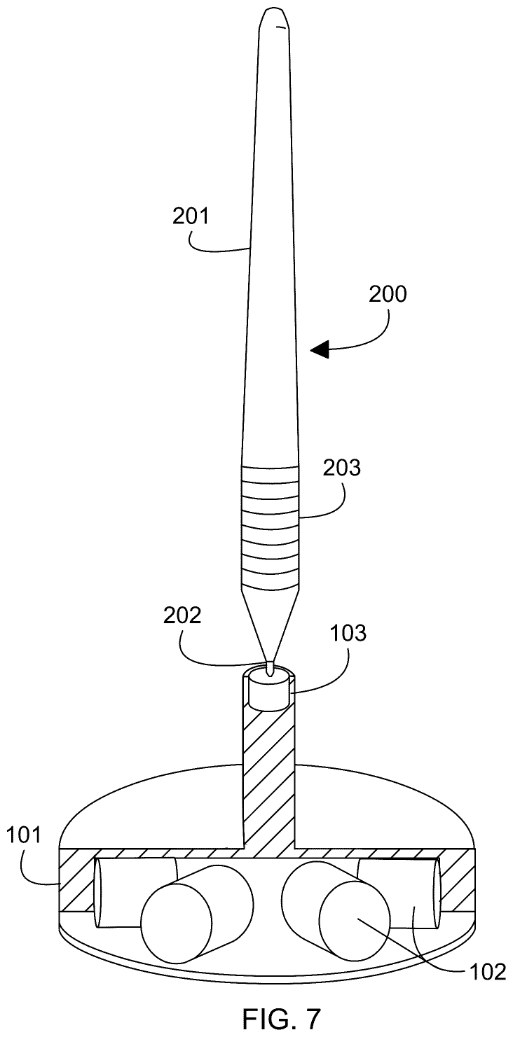

FIG. 7 presents an elevated view of a partial cutaway depicting an alternate preferred embodiment featuring a magnetically balanced detachable member 200 which is disposed upon a base member 100. A first repelling magnetic member 102, which in this embodiment is composed of a plurality of cylindrical magnets which have been oriented with like polls facing inward. This inward facing polarity must match the polarity of the lower face of the second repelling magnetic member 203. First repelling magnetic member 102 is disposed within the body of the base 101. Centered directly above the first repelling magnetic member 102, is a first magnetic anchoring unit 103. A a second magnetic anchoring unit 202 is disposed within the body of the detachable member 200,

and is magnetically disposed upon the first magnetic anchoring unit 103. A second repelling magnetic member 203, which is drawn as a stack of magnets, is disposed within the body of the detachable member 201 above the second magnetic anchoring unit 202. The first repelling magnetic member 102, and the second repelling magnetic member 203 are oriented with like polls facing each other so as to generate a repelling magnetic force strong enough to cause the detachable member 200 to protract away from the base member 100, and stand vertically against gravity. The first magnetic anchoring unit 103, and second magnetic anchoring unit 202 provide a magnetic holding force strong enough to hold the detachable member 200 to the base member 100 against the repelling force while still allowing for easy removal, and placement.

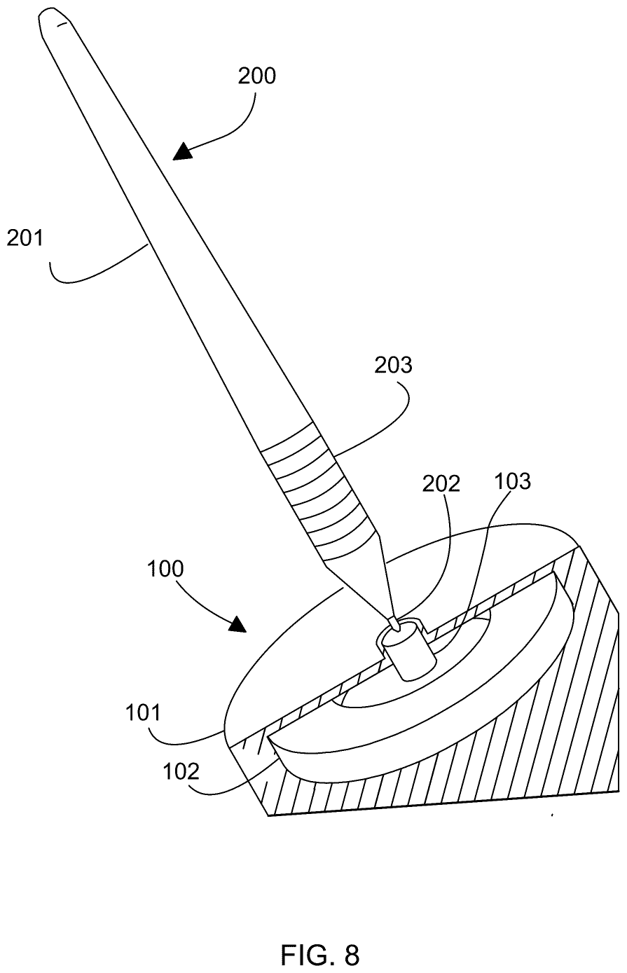

FIG. 8 presents an elevated view of a partial cutaway depicting an alternate preferred embodiment featuring a magnetically balanced detachable member 200 which is disposed upon a base member 100. A first repelling magnetic member 102, which is a strong annular magnet, is disposed within the body of the base 101. Centered directly above the first repelling magnetic member 102, is a first magnetic anchoring unit 103. A a second magnetic anchoring unit 202 is disposed within the body of the detachable member 200, and is magnetically disposed upon the first magnetic anchoring unit 103. A second repelling magnetic member 203, which is drawn as a stack of magnets, is disposed within the body of the detachable member 201 above the second magnetic anchoring unit 202.

The first repelling magnetic member 102, and the first repelling magnetic member 103 have been set at matching angles relative to the horizon, and at an angle that matches the top surface of base member 100. This arrangement influences the angle of detachable member 200 to match the angle of the first repelling magnetic member 102, and the top surface of base member 100. In many arrangements, angular deflection due to gravity is minimal, or virtually nonexistent, but may occur in some arrangements.

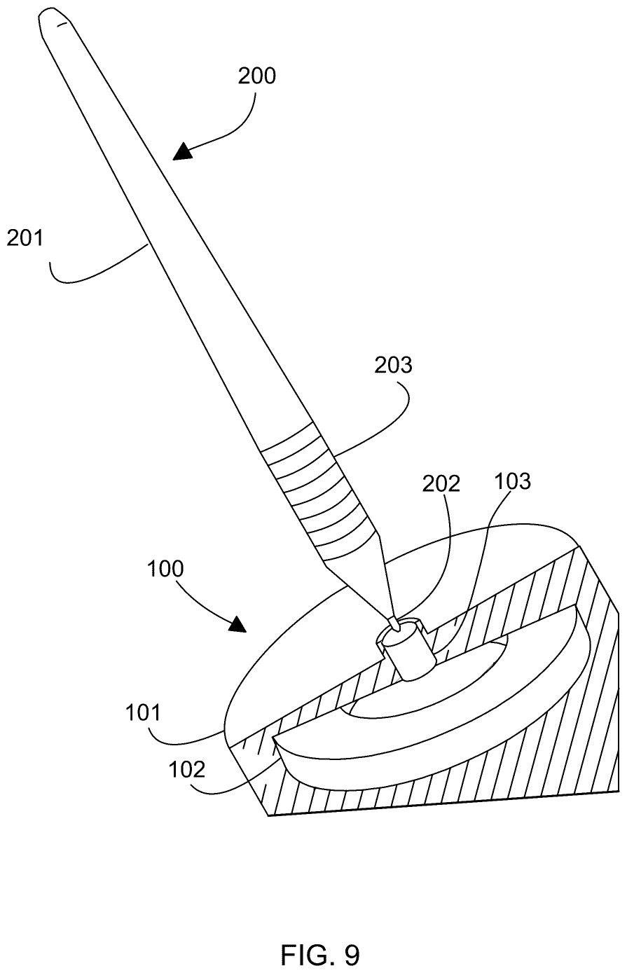

FIG. 9 is related to FIG. 8, but features a first repelling magnetic member set at a slightly different angle than the top surface of base member 100. If the detachable member 200 is suffering deflection due to gravity, this difference in angle produces an asymmetrical repelling magnetic force between the first repelling magnetic member 102, and the second repelling magnetic member 203. as the lower portion of first repelling magnetic member 102 is closer to second repelling magnetic member 203 than the upper portion of the first repelling magnetic member 102.

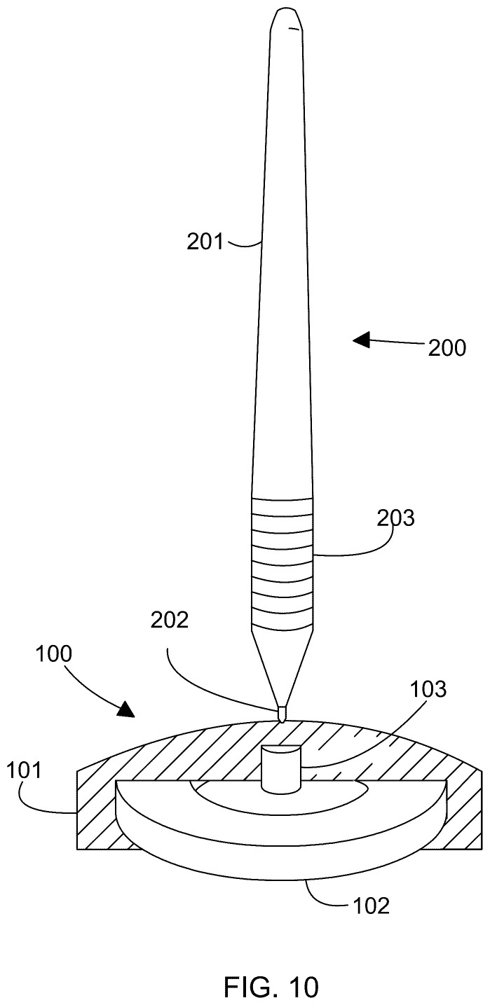

FIG. 10 presents an elevated view of a partial cutaway depicting an alternate preferred embodiment featuring a magnetically balanced detachable member 200 which is disposed upon a base member 100. A first repelling magnetic member 102, which is a strong annular magnet, is disposed within the body of the base 101. Centered directly above the first repelling magnetic member 102, is a first magnetic anchoring unit 103. A second magnetic anchoring unit 202 is disposed within the body of the detachable member 200, and is magnetically disposed upon the domed top surface of base member 100. The attractive magnetic force generated between the first magnetic anchoring unit 103, and the second magnetic anchoring unit 202 can be strong enough to anchor the detachable member 200 to the base member 100 through up to about 5 mm of non-magnetic material. A second repelling magnetic member 203, which is drawn as a stack of magnets, is disposed within the body of the detachable member 201 above the second magnetic anchoring unit 202. The first repelling magnetic member 102, and the second repelling magnetic member 203 are oriented with like polls facing each other so as to generate a repelling magnetic force strong enough to cause the detachable member 200 to protract away from the base member 100, and stand vertically against gravity. The first magnetic anchoring unit 103, and second magnetic anchoring unit 202 provide a magnetic holding force strong enough to hold the detachable member 200 to the base member 100 against the repelling force while still allowing for easy removal, and placement.

FIG. 11 presents an elevated view of a partial cutaway depicting an alternate preferred embodiment featuring a magnetically balanced detachable member 200 which is disposed upon a base member 100. A first repelling magnetic member 102, which is a strong annular magnet, is disposed within the body of the base 101. Set off center from the first repelling magnetic member 102, is a first magnetic anchoring unit 103. A second magnetic anchoring unit 202 is disposed within the body of the detachable member 200, and is magnetically disposed upon the first magnetic anchoring unit 103. A second repelling magnetic member 203, which is drawn as a stack of magnets, is disposed within the body of the detachable member 201 above the second magnetic anchoring unit 202.

The first repelling magnetic member 102, and the second repelling magnetic member 203 are oriented with like polls facing each other so as to generate a repelling magnetic force strong enough to cause the detachable member 200 to protract away from the base member 100, and stand at an angle against gravity. The first magnetic anchoring unit 103, and second magnetic anchoring unit 202 provide a magnetic holding force strong enough to hold the detachable member 200 to the base member 100 against the repelling force while still allowing for easy removal, and placement. This arrangement produces an asymmetrical repelling force upon detachable member 200. This asymmetrical force holds the detachable member 200 at a preferred angle, and orientation, and resists deflection due to external forces such as, but not limited to gravity, and air current.

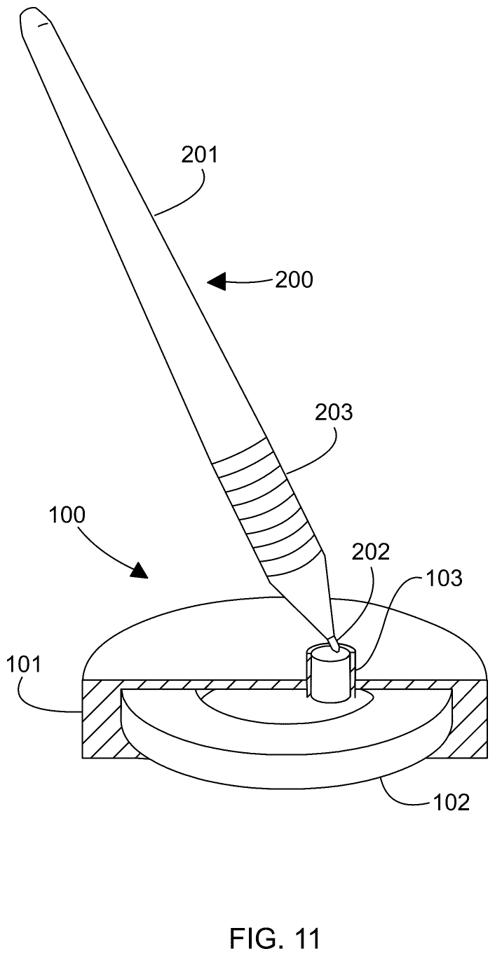

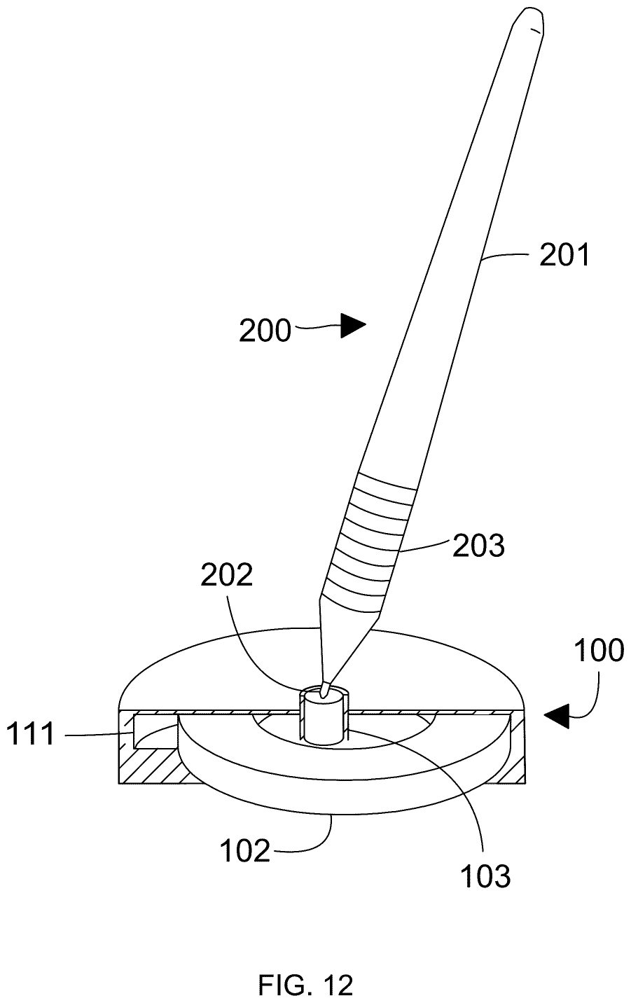

FIG. 12 is related to FIG. 11, but includes the ability to move the first repelling magnetic member through slot A 111 within the base member 100 by various means such as, but not limited to a sliding mechanism, a screw, a button, or a switch. These options have not been drawn, as they are numerous, and are known to those skilled in the art. The ability to move the first repelling magnetic member allows the user to change the angle, and preferred orientation, or direction in which the detachable member 200 protracts from the base member 100.

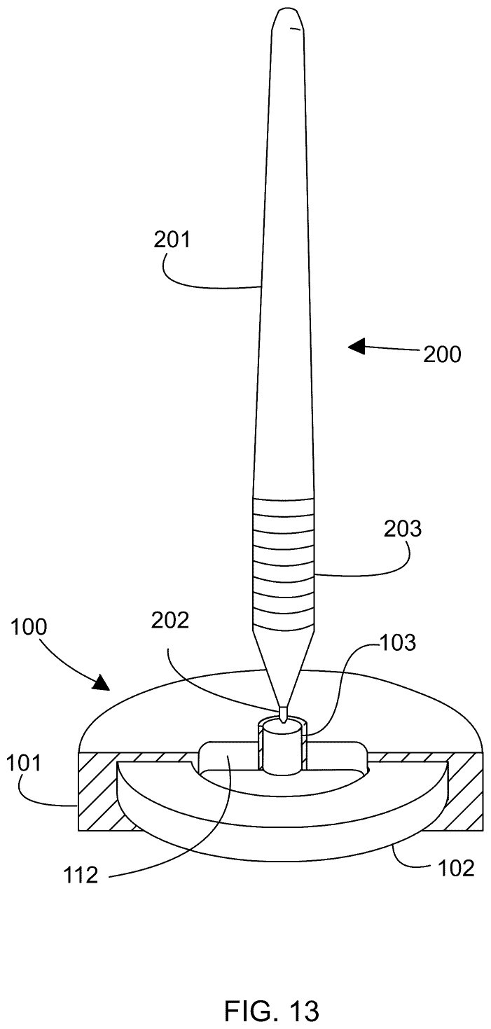

FIG. 13 is related to FIG. 12, but as opposed to the arrangement in FIG. 12 in which the first repelling magnetic member 102 is movable, the first anchoring magnetic unit is movable through slot B 112.

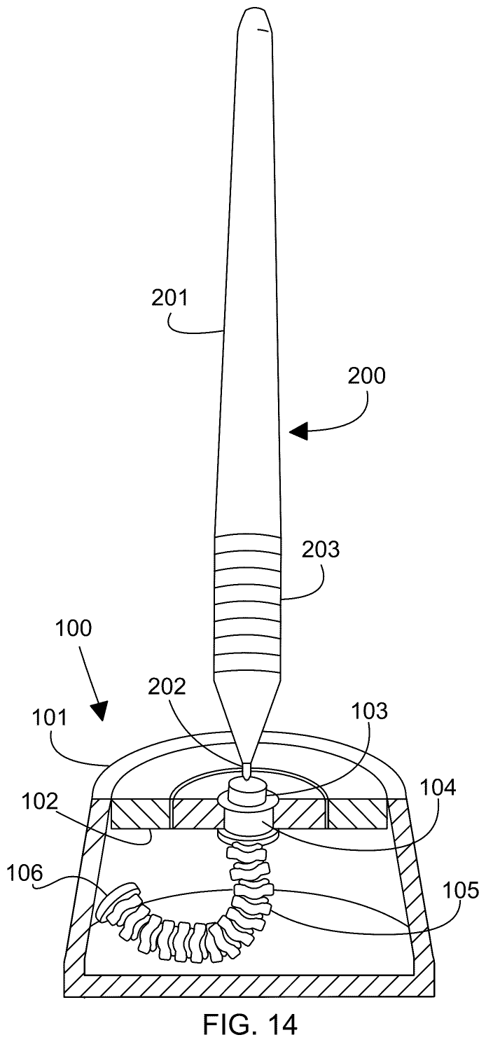

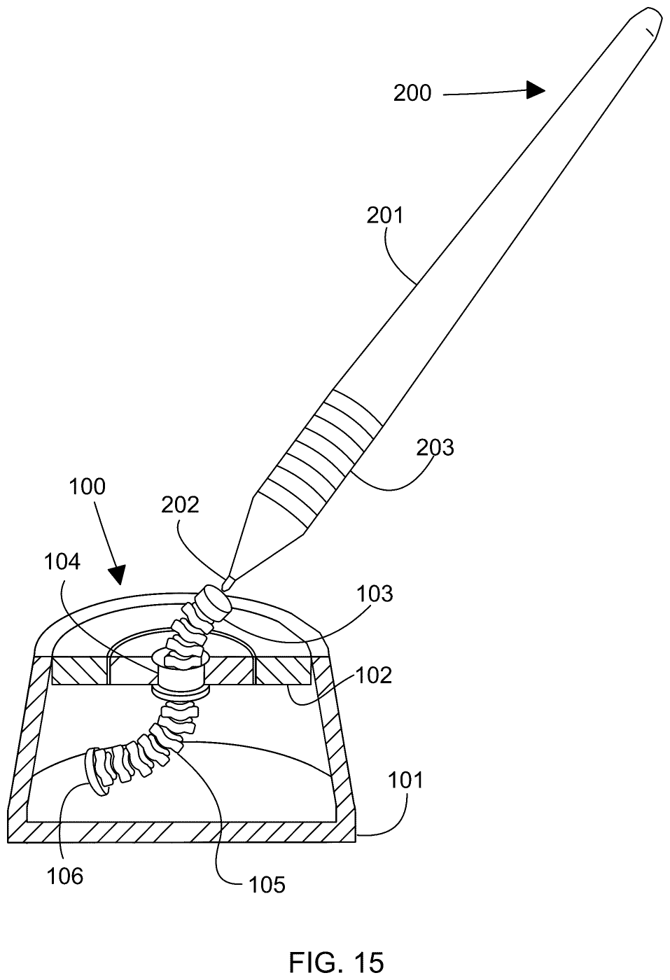

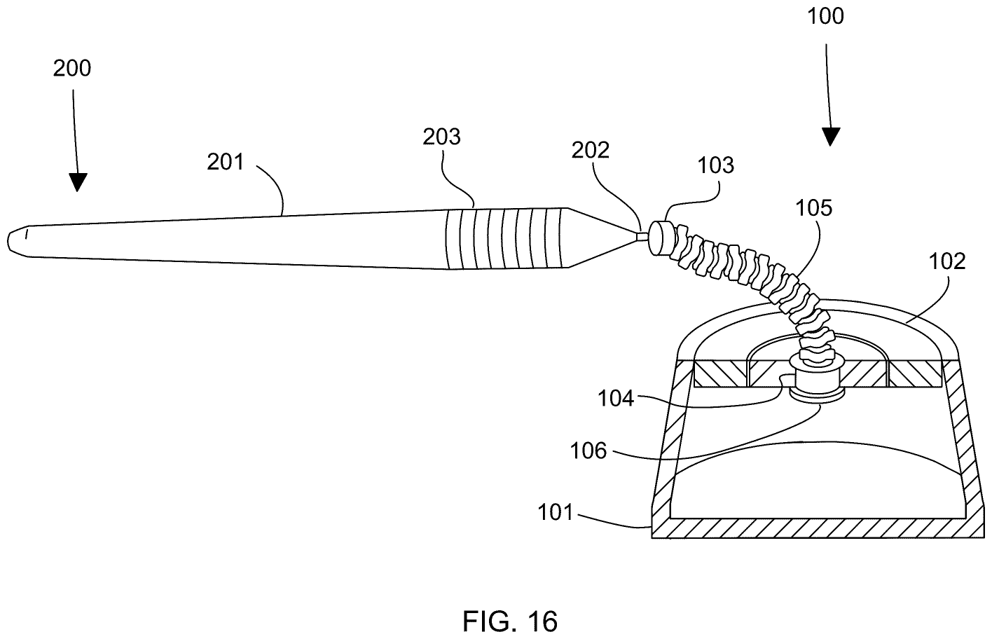

FIGS. 14, 15, and 16 are related to FIGS. 4,5, and 6. This embodiment allows the user to customize their experience by changing the location, and orientation of the first magnetic anchoring unit 103 in relation to the first repelling magnetic member 102, and thus changing the angle, and location of the detachable member 200. This embodiment has been provided to demonstrate the broad range of configurations provided by this disclosure.

Presented are three elevated views of a partial cutaway depicting an alternate preferred embodiment in three different poses featuring a magnetically balanced detachable member 200 which is disposed upon a base member 100. A first repelling magnetic member 102, which is a strong annular magnet, is disposed within the body of the base 101. Disposed within the base member 100 is a flexible oil tube 105 which can also telescope in and out of the base member 100. A snug rubber bushing 105 allows the user to adjust the exposed length of the tube 105 without it being able to move on its own. a pop rivet 106 has been inserted in to the lower end of the tube 105 to serve as a stop block which prevents the tube 105 from being pulled free from the base 100. The first magnetic anchoring unit 103 has been affixed to the top end of the tube 105 A second magnetic anchoring unit 202 is disposed within the body of the detachable member 200, and is magnetically disposed upon the first magnetic anchoring unit 103. A second repelling magnetic member 203, which is drawn as a stack of magnets, is disposed within the body of the detachable member 201 above the second magnetic anchoring unit 202. The first repelling magnetic member 102, and the second repelling magnetic member 203 are oriented with like polls facing each other so as to generate a repelling magnetic force strong enough to cause the detachable member 200 to protract away from the base member 100, and stand vertically against gravity. The first magnetic anchoring unit 103, and second magnetic anchoring unit 202 provide a magnetic holding force strong enough to hold the detachable member 200 to the base member 100 against the repelling force while still allowing for easy removal, and placement.

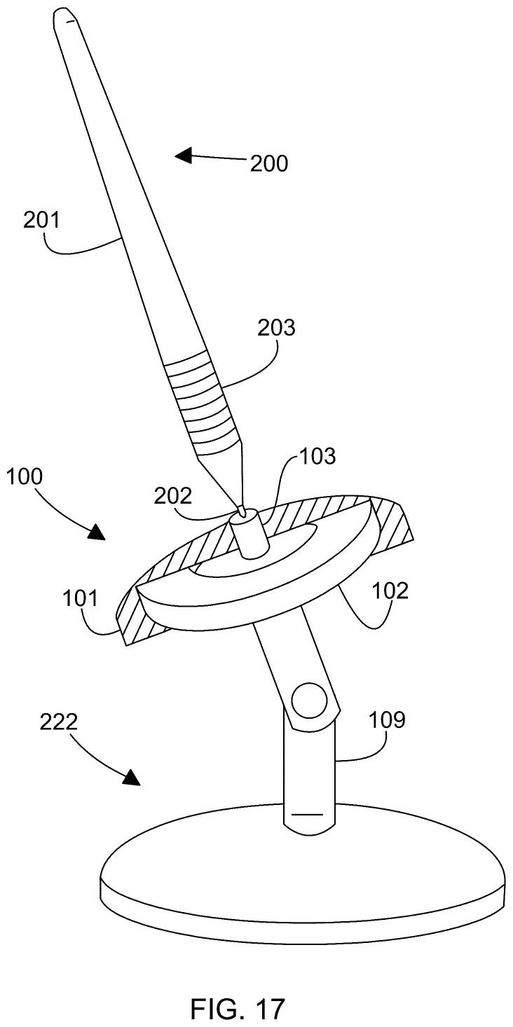

FIG. 17 is related to FIG. 2, but has been mounted to a stand 222 by way of an articulated arm 109 allowing the user to change the angle of the base member 100, and thus the angle of the detachable member 200 relative to the horizon.

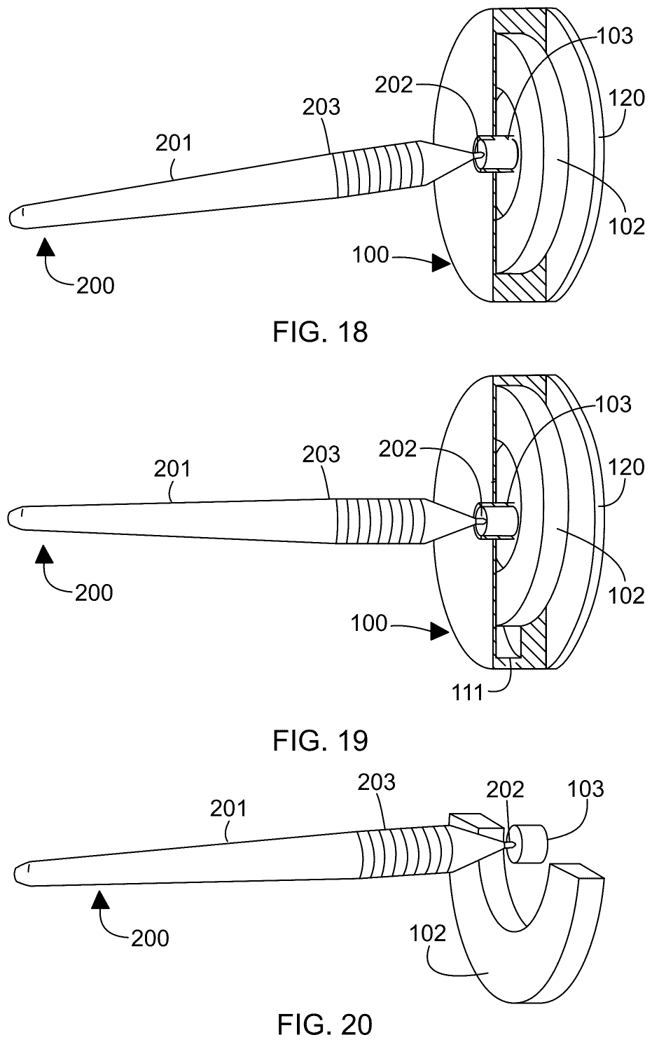

FIG. 18 is related to FIG. 2, but has an adhesive backing 120 provided so as to be able to attach the base member 100 to a vertical surface such as a wall. Detachable member 200 is depicted as suffering from gravitational deflection. Other means of vertically mounting base member 100 can be used as well. Such means, and methods will be obvious to anyone skilled in the art.

FIG. 19 is related to FIGS. 12, and 18. A movable first repelling magnetic member 102 has been provided as a means of counteracting downward deflection of detachable member 200 due to gravity.

FIG. 20 is related to FIG. 18 as well. The body of the base member 101 has been omitted for clarity. In this embodiment, to counteract downward deflection, only half of an annular magnet has been employed as the first repelling magnetic member 102 to generate an asymmetrical repelling force, and as such, the other half of the magnet is not needed.

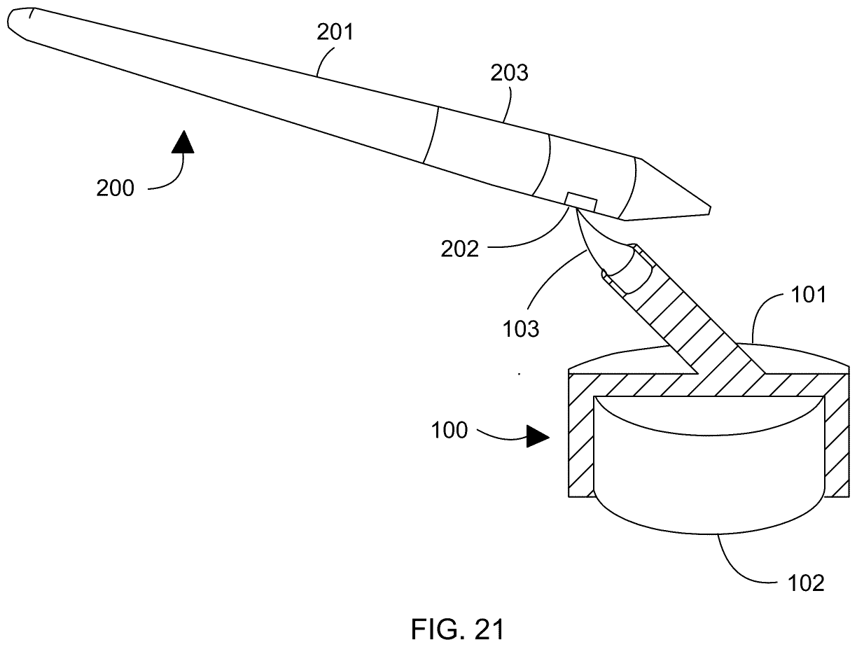

FIG. 21 is related to FIG. 5, but the first magnetic anchoring unit 103 has been stylized, and is a concatenation of a magnetic dipole, and a shaped element made from a ferromagnetic material. This embodiment also features the second anchoring magnetic unit 202 as being disposed in the side wall of the detachable member 200.

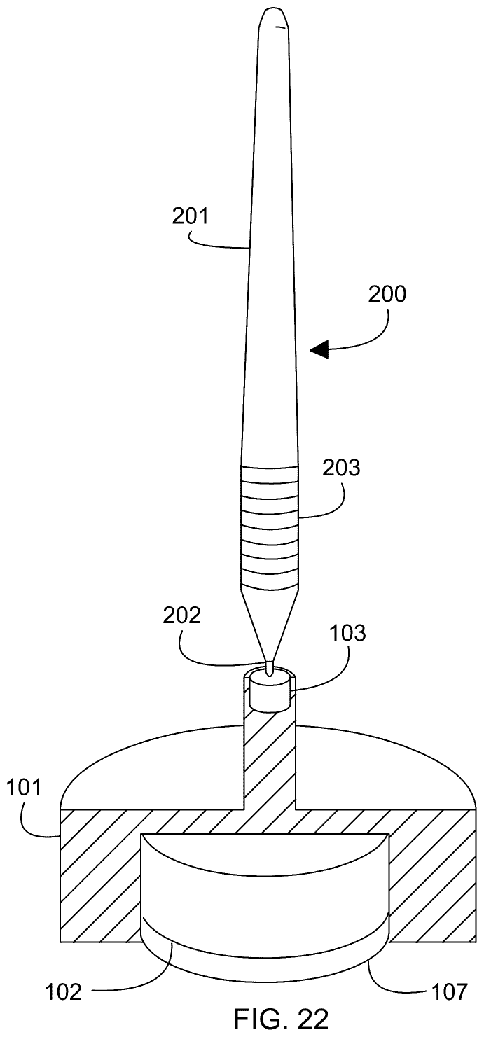

FIG. 22 is related to FIG. 1, but has been enhanced by affixing a flux guide 107 to the bottom of the first repelling magnetic member 102. This enhancement shapes the magnetic field so that it no longer interacts with ferromagnetic materials below the base member 100 such as a steel-top desk. The magnetic field emanating from the top is also strengthened allowing for the use of smaller, and less expensive magnets to achieve the same function.

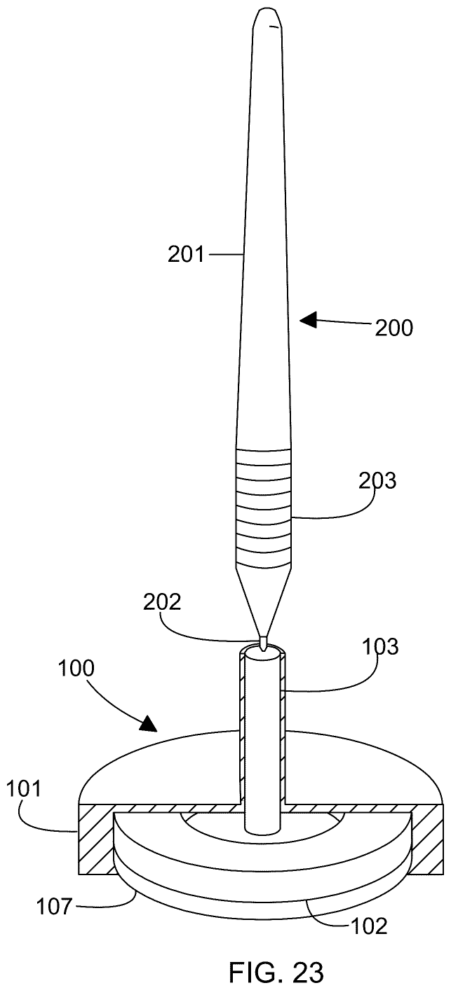

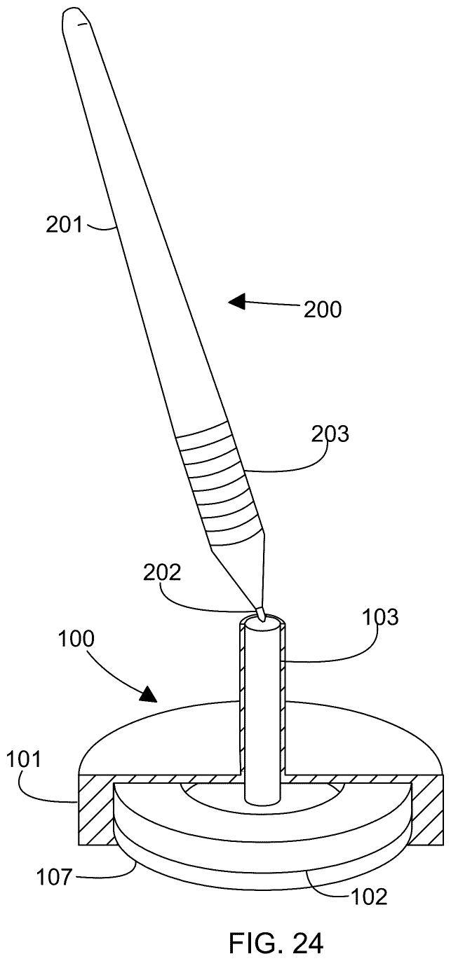

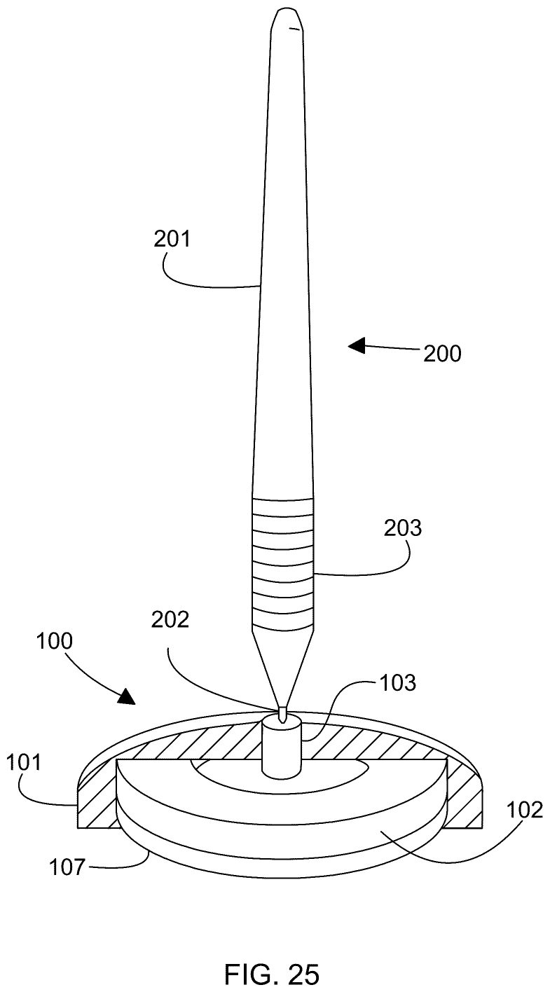

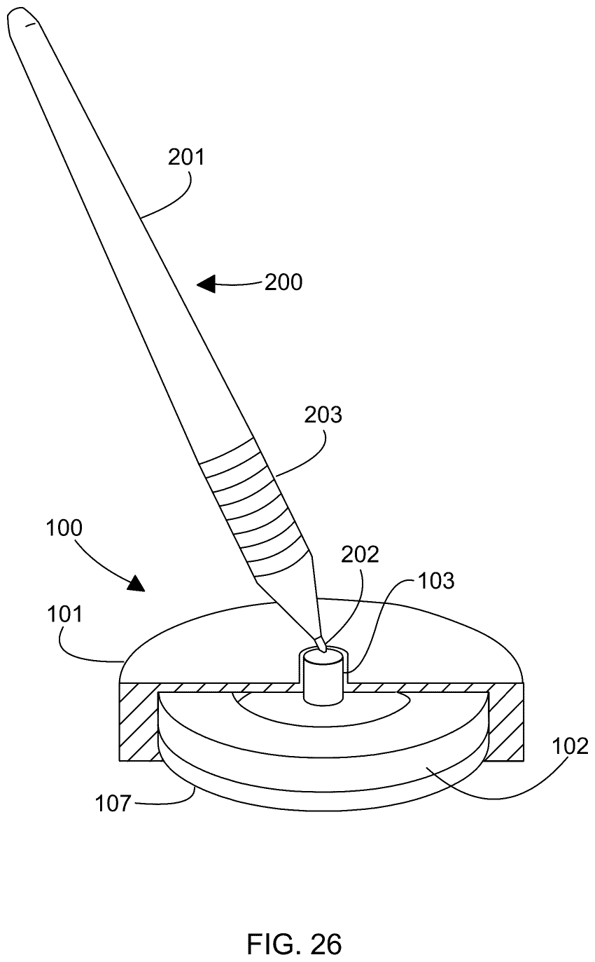

FIGS. 23, 24, 25, and 26 are related to FIGS. 2, and 22. They feature an annular magnet serving as the first repelling magnetic member 102, and are all enhanced with flux guides 107. What is unique is that both the first repelling magnetic member 102, and the first anchoring magnetic unit 103 are both attached to the flux guide. These two magnets are oriented with their polls facing in opposite directions, and affixed to the flux guide 107, thus they share their fields with each other, and the three parts become a concatenation serving as a single magnetic member with both north, and south polls facing in the same direction just like a horseshoe magnet. In this arrangement, the first anchoring magnetic unit 103 can be constructed of ferromagnetic material, and the concatenation will still function virtually the same.

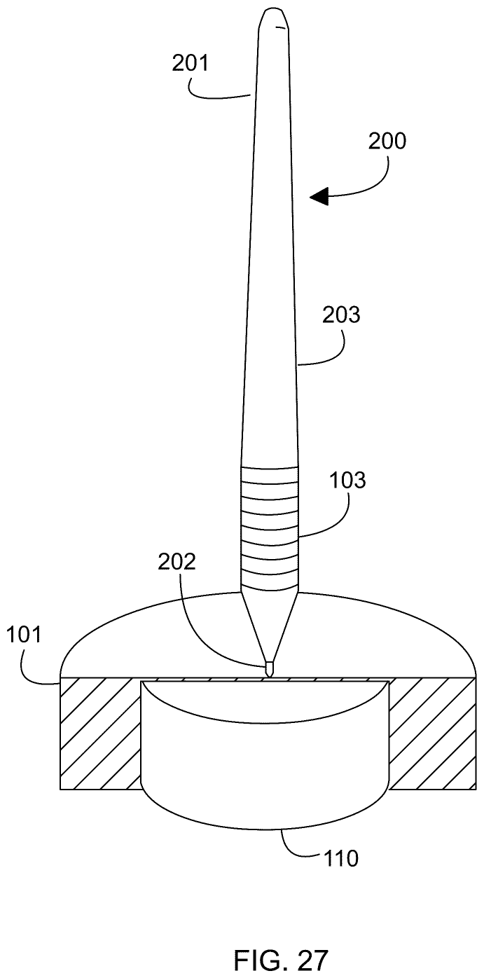

FIG. 27 features a base member 100 containing only a single large magnet 110 which provides a repelling magnetic force when interacting with the second repelling magnetic member 103, and an attractive magnetic force when interacting with the second anchoring magnetic unit 202. The full explanation of how the components interact with each other has already been reiterated several times, and as the basic functions within all embodiments are virtually the same, or substantially similar, those details are being omitted.

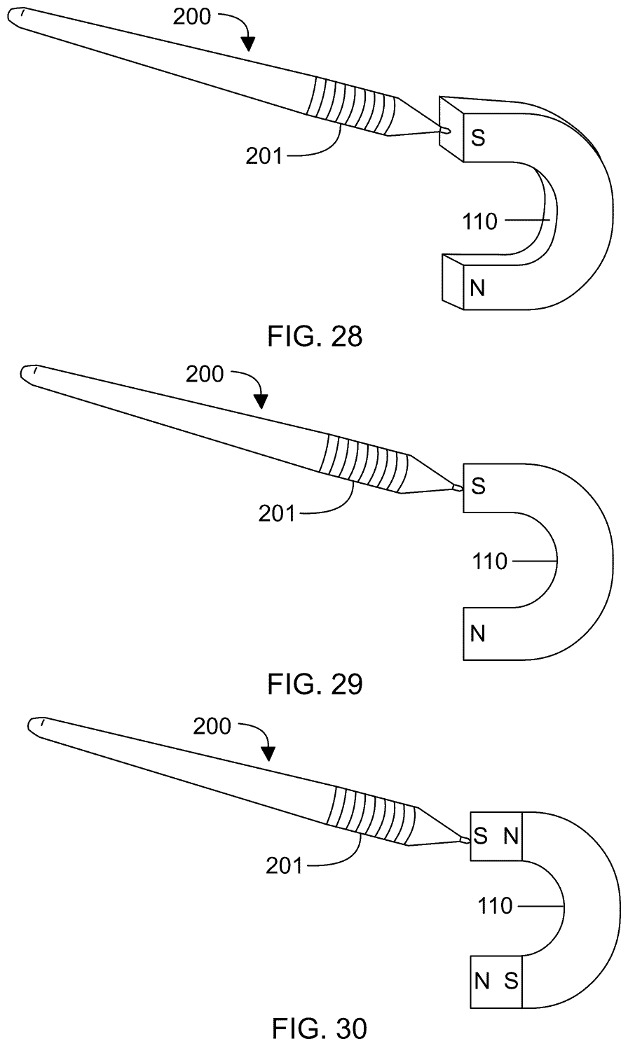

FIGS. 28, 29, and 30 depict a single horseshoe magnet serving as a single magnetic member as in FIG. 27. The body of the base member 100 has been omitted for simplicity. The full explanation of how the components interact with each other has already been reiterated several times, and as the basic functions within all embodiments are virtually the same, or substantially similar, those details are being omitted. FIG. 28 is shown in elevated perspective. FIG. 29 is shown in profile. FIG. 30 is shown in profile, and depicts single magnet 100 as being constructed from a concatenation of two magnetic dipoles, and a ferromagnetic flux guide.

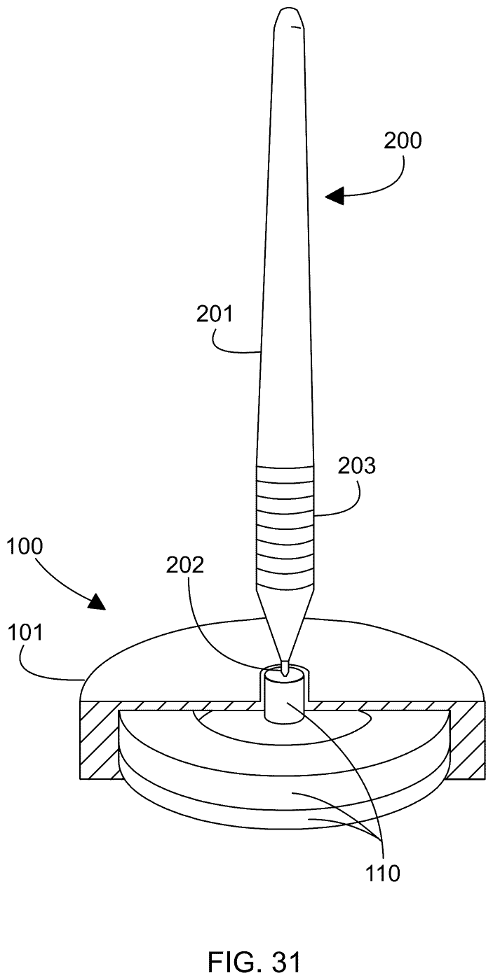

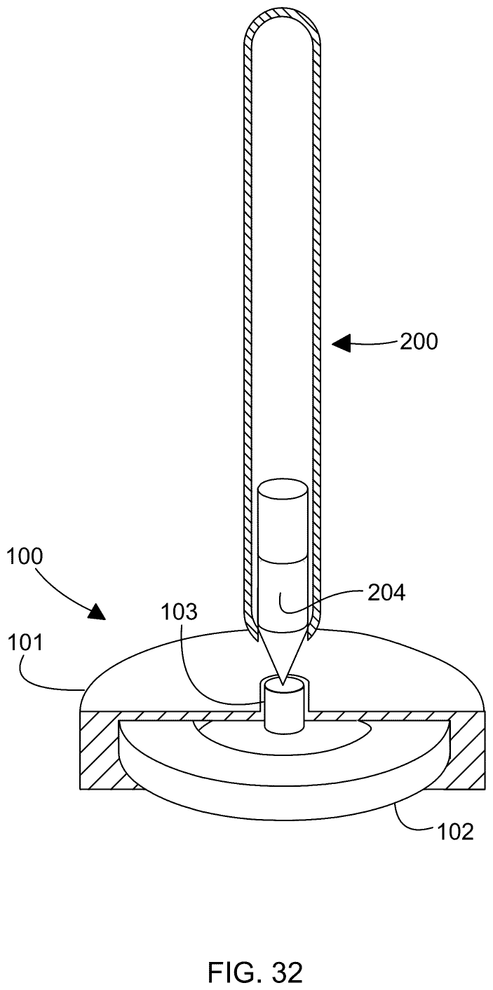

FIG. 31 depicts all of the magnetic elements of the base member 100 as being a concatenation, and thus a single first magnetic member 110.

FIG. 23 is related to FIG. 31, accept all of the magnetic elements of the detachable member 200 have been replace by a concatenation, or single magnet serving as a second single magnetic member 204.

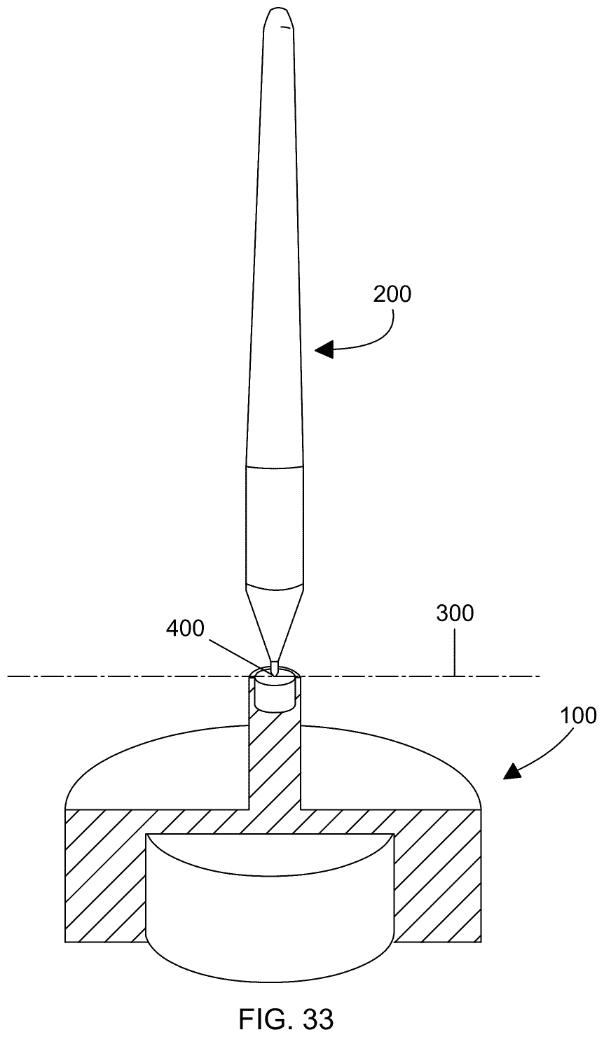

FIG. 33 depicts a preferred embodiment, and shows a plane of separation bisecting the point of contact between the base member 100, and the detachable object 200, and is related to claim 15.

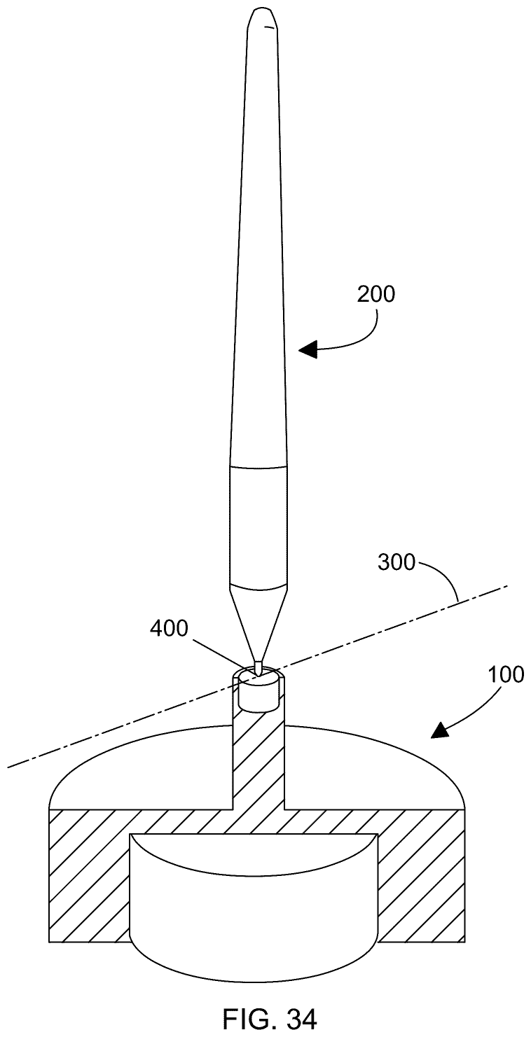

FIG. 34 depicts a preferred embodiment, and shows a plane of separation bisecting the point of contact between the base member 100, and the detachable object 200, and is related to claim 16.

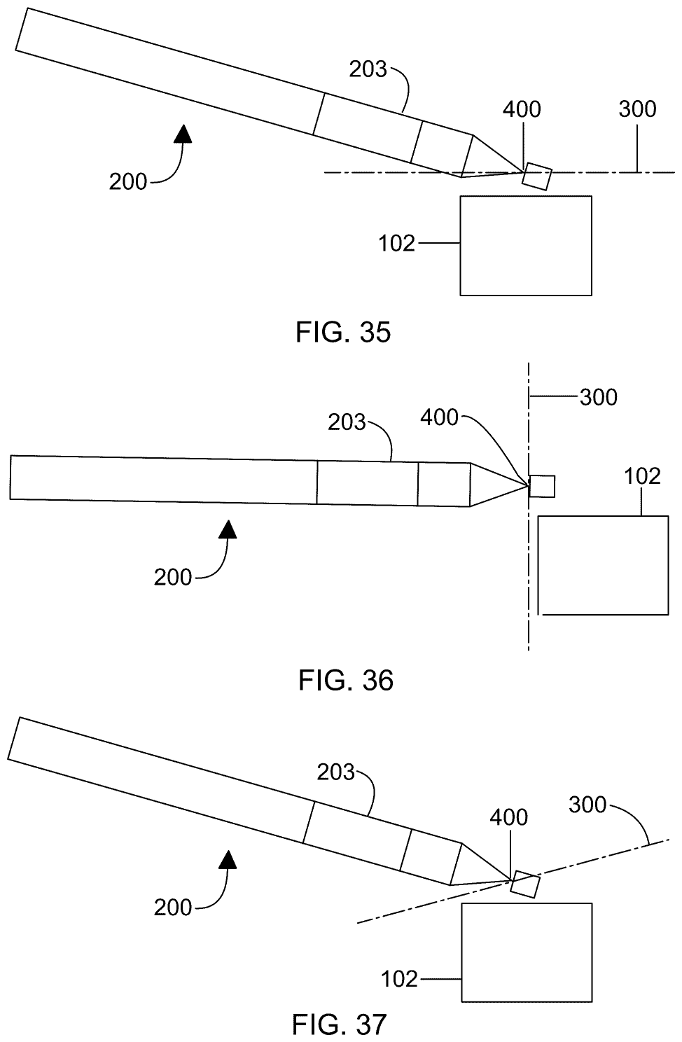

FIG. 35 depicts an embodiment in which the body of the base member 101 has been omitted for clarity, and shows a plane of separation bisecting the point of contact between the base member 100, and the detachable object 200, and is related to claim 17.

FIG. 36 depicts an embodiment in which the body of the base member 101 has been omitted for clarity, and shows a plane of separation bisecting the point of contact between the base member 100, and the detachable object 200, and is related to claim 18.

FIG. 37 depicts an embodiment in which the body of the base member 101 has been omitted for clarity, and shows a plane of separation bisecting the point of contact between the base member 100, and the detachable object 200, and is related to claim 19.

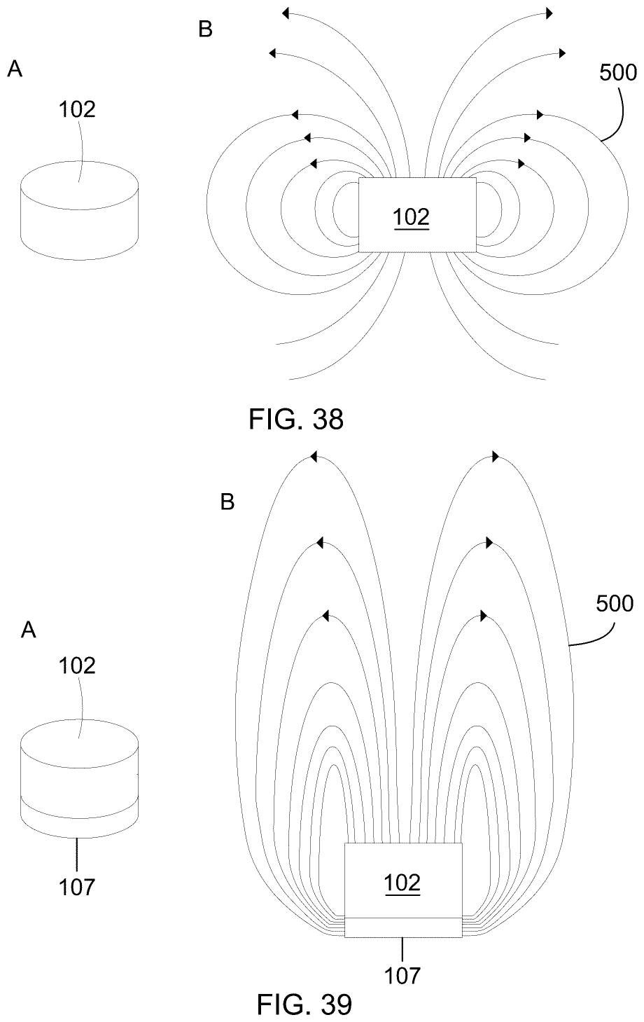

FIG. 38 depicts a cylindrical magnet 102 in elevated perspective designated by A, and a cylindrical magnet 102 with lines of flux 500 in profile designated by B.

FIG. 39 depicts a cylindrical magnet with flux guide 107 in elevated perspective designated by A, and a cylindrical magnet with flux guide and lines of flux 500 in profile designated by B.

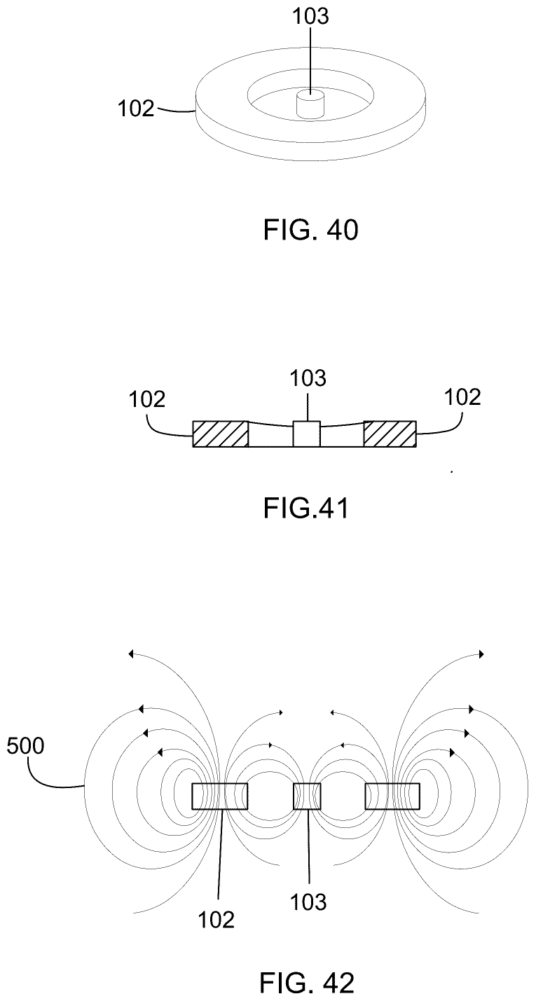

FIG. 40 depicts an annular magnet 102 with a concentric cylinder magnet 103 in elevated perspective.

FIG. 41 depicts a cross section of an annular magnet 102 with a concentric cylinder magnet 103 in profile.

FIG. 42 depicts a cross section of an annular magnet 102 with a concentric cylinder magnet 103 and lines of flux 500 in profile.

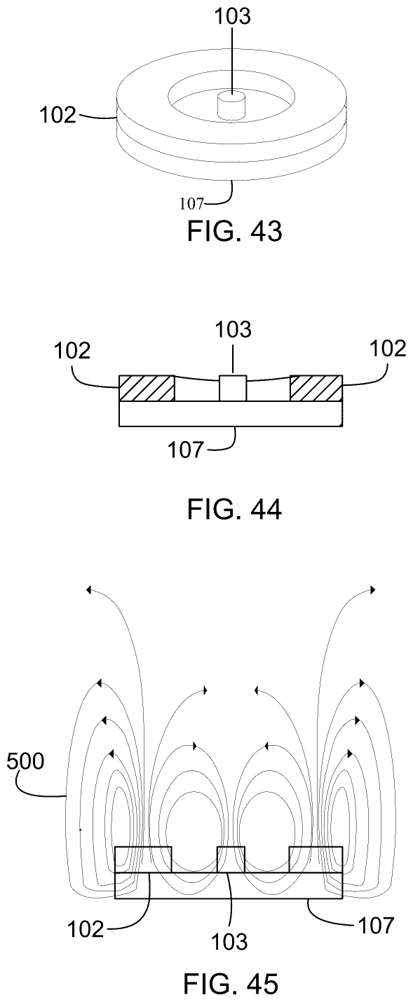

FIG. 43 depicts an annular magnet 102 with a concentric cylinder magnet 103 and a flux guide 107 in elevated perspective.

FIG. 44 depicts a cross section of an annular magnet 102 with a concentric cylinder magnet 103 and a flux guide 107 in profile.

FIG. 45 depicts a cross section of an annular magnet 102 with a concentric cylinder magnet 103, a flux guide 107, and lines of flux 500 in profile.

FIGS. 38 through 45 are provided for visual aids in addressing a major problem in the prior art, and a solution provided by this disclosure. When a device operates based on carefully balanced forces, any change that occurs that causes an imbalance between these forces will result in the device operating incorrectly, or not at all.

In the prior art, a magnetically balanced pen, and base set has been disclosed in which an annular magnet is concentrically aligned with a disc magnet, and housed in a flat base member which is set on a flat horizontal surface. The pen is then set on the base member, and magnetic interactions between the base member, and the pen cause the pen to stand upright against the force of gravity. However, this design is incompatible with steel top desks which are extremely common, especially in office settings. Other surfaces such as steel tables, filing cabinets, and the like present the same problem.

Likewise, desks, tables, and other pieces of furniture containing steel members such as brackets, framing, drawer slides, and the like present a similar problem. These problems include having the base member stick powerfully, and frustratingly to the desk top. in a case where there are steel framing members running below a non ferrous desk top, the base will tend to be pulled toward these members through the desk top, and stick to the desk top where these members are located. In combination with these issues, a much more serious issue arises. Referring to FIGS. 38, and 42, magnetic lines of flux 500 are shown in an unaltered state. In contrast, FIGS. 39, and 45 depict magnetic lines of flux 500 as influenced by a ferromagnetic member 107. If the device from the prior art as mentioned above were to be placed on to a ferromagnetic surface, the functionality would be broken. The above mentioned device was designed to function as depicted in FIG. 42. By placing the device on a ferromagnetic surface, the functionality is broken by altering the lines of flux 500 to behave as depicted in FIG. 45. The repelling magnetic force within the device becomes much greater than intended resulting in the balanced pen being ejected from the base.

Other problems can occur when the powerful magnets in these devices interact with item stored in drawers beneath a top that is not ferromagnetic. Pens, paperclips, tacks, staples, and other such common items found in an office setting can be pulled up within drawers, and can stick to the under side of the desk top. Other problems can occur such as interference with magnetically sensitive items such as credit cards, and other magnetic media stored in drawers close to the desk top. Solutions presented within this disclosure eliminate all of the problems mentioned above.

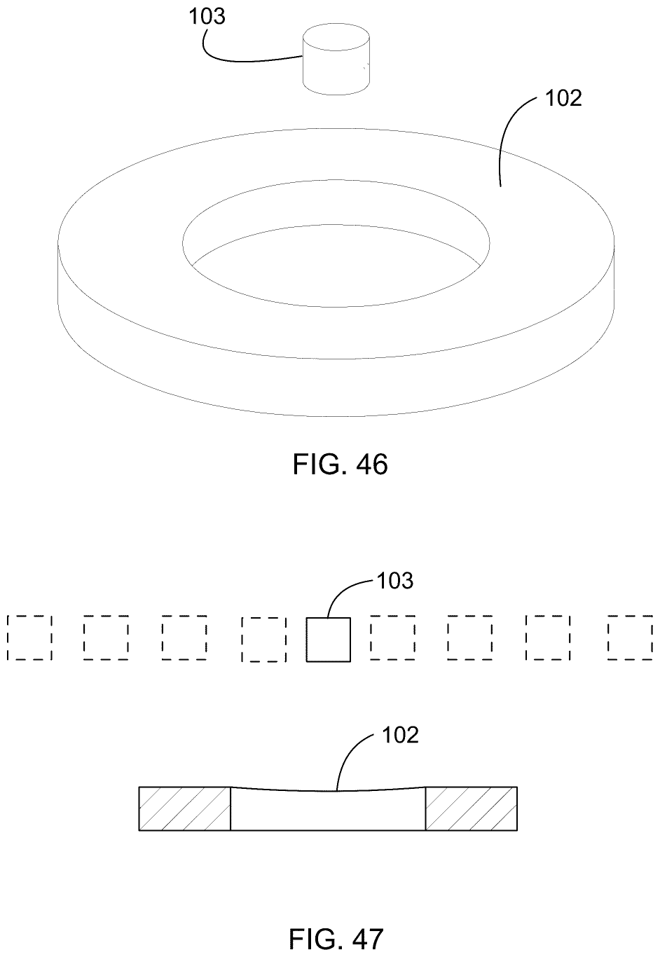

FIG. 46 shows an elevated perspective of a small cylinder magnet 103 centered above an annular magnet 102.

FIG. 47 shows a profile view of a small cylinder magnet 103 centered above an annular magnet 102. Several alternative positions of the cylinder magnet 103 are drawn with broken lines.

This is not an all inclusive range, it is only a finite sampling, and does not even include variations in elevation, or rotation. This depiction is to help demonstrate that this disclosure allows for a vast array of configurations.

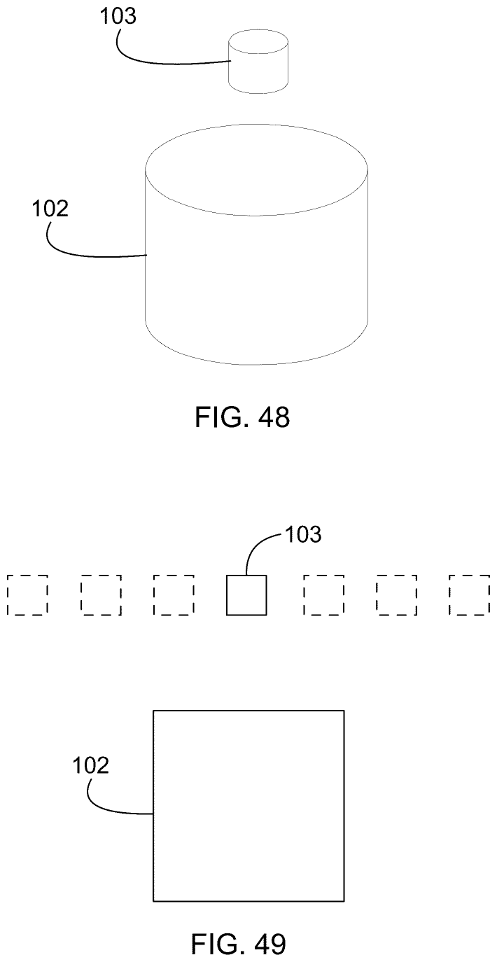

FIG. 48 shows an elevated perspective of a small cylinder magnet 103 centered above a larger cylinder magnet 102.

FIG. 49 shows a profile view of a small cylinder magnet 103 centered above a larger cylinder magnet 102. Several alternative positions of the cylinder magnet 103 are drawn with broken lines. This is not an all inclusive range, it is only a finite sampling, and does not even include variations in elevation, or rotation. This depiction is to help demonstrate that this disclosure allows for a vast array of configurations.

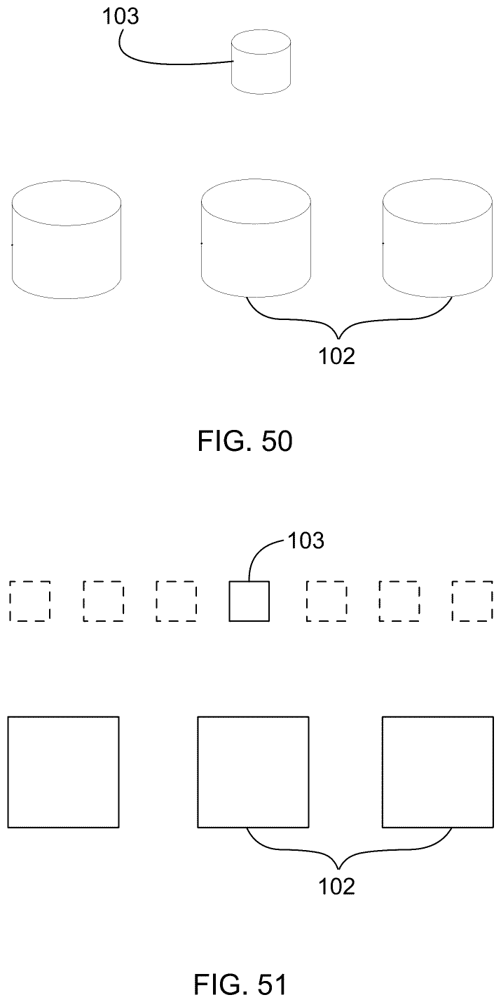

FIG. 50 shows an elevated perspective of a small cylinder magnet 103 centered above a a plurality of larger cylinder magnets 102.

FIG. 51 shows a profile view of a small cylinder magnet 103 centered above a a plurality of larger cylinder magnets 102. Several alternative positions of the small cylinder magnet 103 are drawn with broken lines. This is not an all inclusive range, it is only a finite sampling, and does not even include variations in elevation, or rotation. This depiction is to help demonstrate that this disclosure allows for a vast array of configurations.

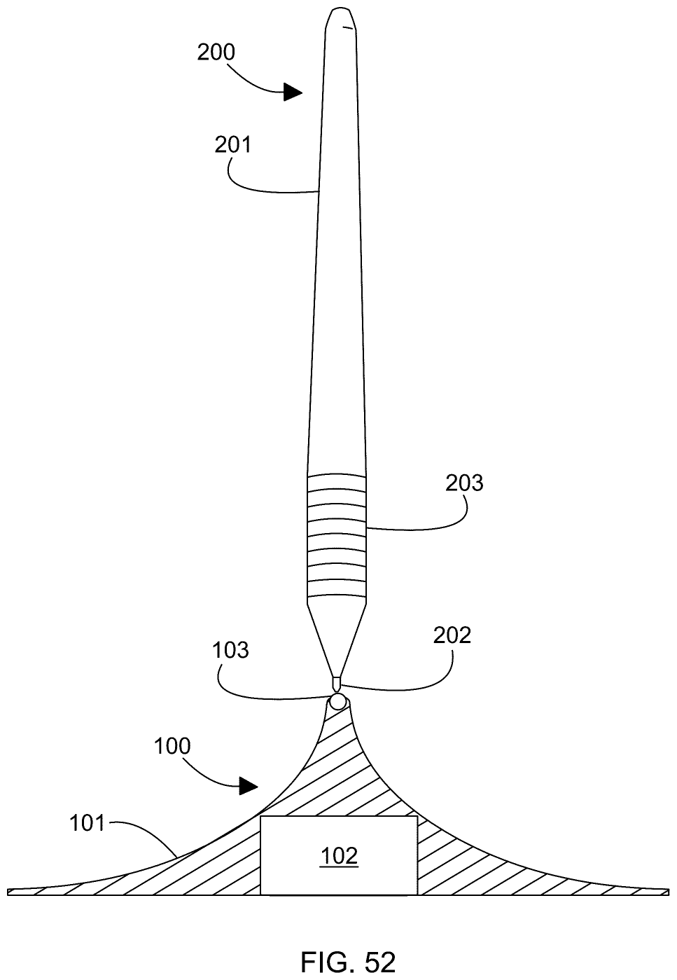

FIG. 52 is a more artistic, and commercially viable variation of the embodiment depicted in FIG. 1, and is being provided to show variation within the scope of embodiments.

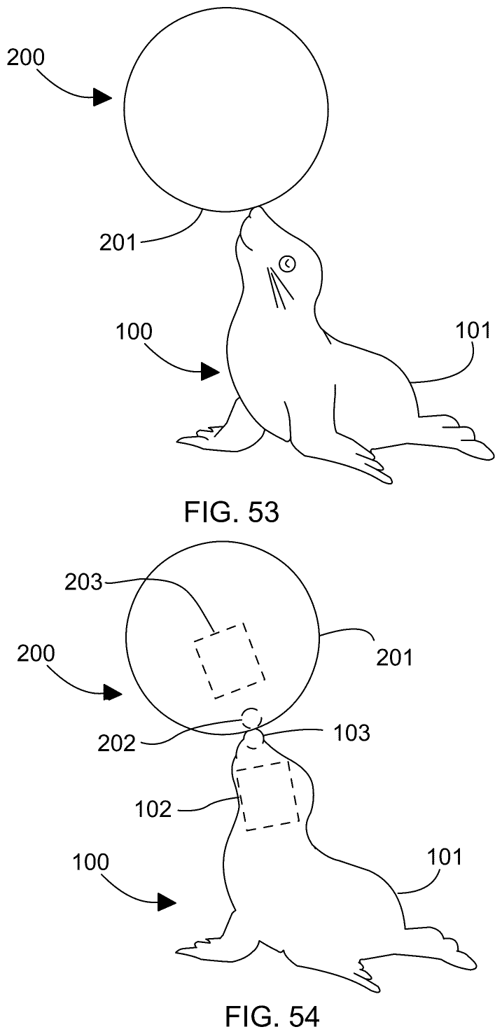

FIG. 53 features a detachable member 200 in the form of a stress ball being balanced on the nose of a seal shaped base member 100, and is related to FIG. 5 This embodiment is being provided to show variation within the scope of embodiments.

FIG. 54 is a front view of a stress ball 200 balanced on the nose of a seal base member 100 and is related to FIG. 53. Internal magnetic members 102, 103, 202, and 203 are drawn with broken lines.

Some details have been omitted for clarity.

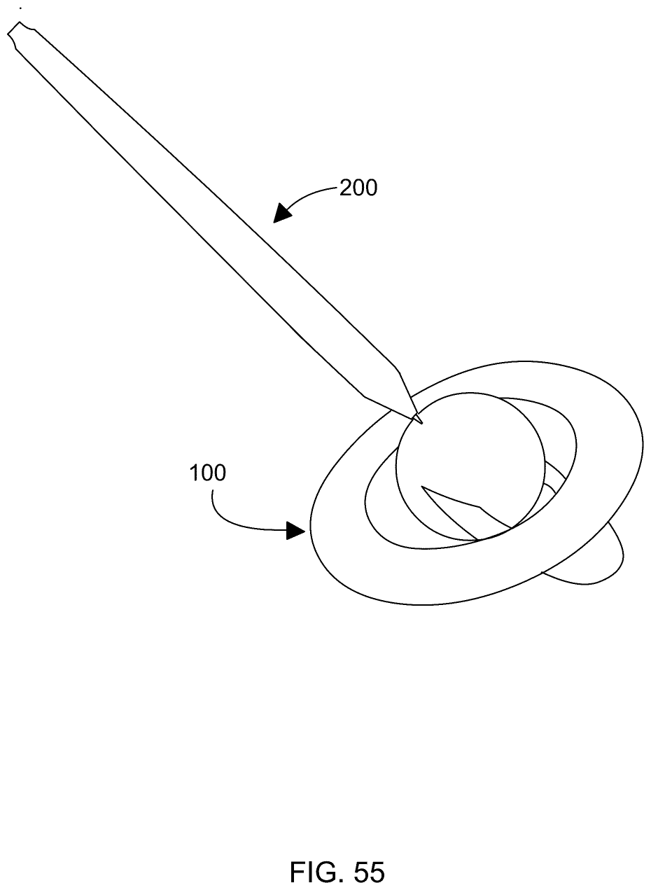

FIG. 55 is related to FIG. 5 and is a simple line drawing of a pen 200 balanced on an artistic base member 100 and is provided to demonstrate the versatility of the current disclosure.

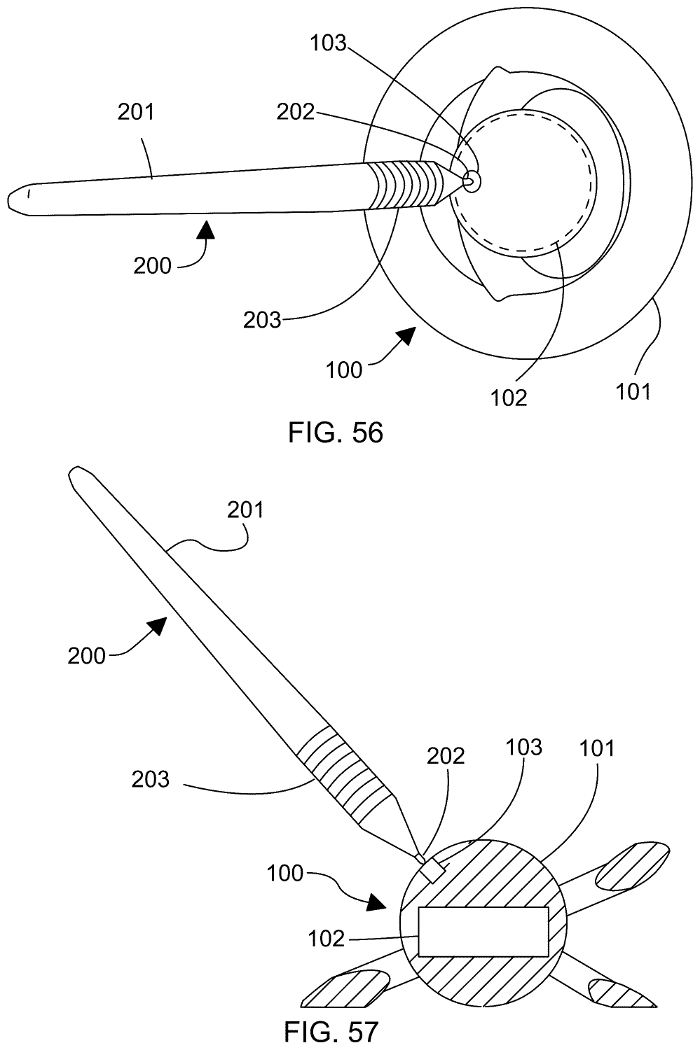

FIG. 56 is a top down view of the pen 200 and base 100 from FIG. 55.

FIG. 57 is a front view of a partial cutaway of the pen 200 and base 100 from FIG. 55.

FIG. 58 is related to FIG. 6 and is a simple line drawing of a pen 200 resting horizontally in mid air, and attached by a single point of contact to an artistic base member 100, and is provided to demonstrate the versatility of the current disclosure.

FIG. 59 depicts the pen 200 and base 100 from FIG. 58 drawn in profile. Internal magnetic members 102, 103, 202, and 203 are drawn with broken lines.

FIG. 60 is a top-down view of the pen 200 and base 100 from FIG. 58. Internal magnetic members 102, 103, 202, and 203 are drawn with broken lines.

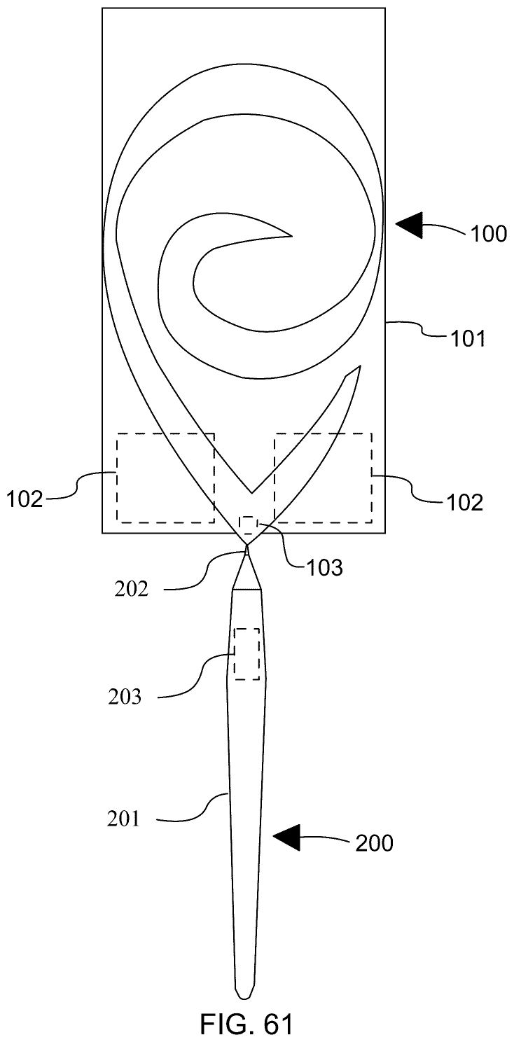

FIG. 61 is a top-down view of the pen 200 and base 100 from FIG. 58 and depicts a plurality of repelling magnets 102 in the base member 100. Internal magnetic members 102, 103, 202, and 203 are drawn with broken lines.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

1. A magnetic support for pens and the like, the magnetic support comprising:
a base member having at least one resting side;
a first repelling magnetic member comprising at least one permanent magnet disposed at a predetermined position within said base member having at least a front polar face, and a back polar face opposite each other, and having said front polar face oriented away from said resting side of said base member and;
a first magnetic anchoring unit having at least a front side, and a back side opposite each other, and being disposed within said base member having said front side oriented away from said front polar face of said first repelling magnetic member, and oriented away from said resting side of said base member, and having said front side more distal from said resting side than said front polar face; and
a detachable object removably disposed upon said base member by way of a single point of contact comprising:
a body with at least a proximal end, and a distal end opposite each other,
a second magnetic anchoring unit disposed within said proximal end of said detachable object which is magnetically attracted to said first magnetic anchoring unit providing an attractive force necessary to hold said detachable object to said base member, and a second repelling magnetic member having at least a first polar face, and a second polar face opposite each other wherein said first polar face has the same polarity as said front polar face of said first repelling magnetic member, and being disposed between said second magnetic anchoring unit, and said distal end, and magnetically interacting with said first repelling magnetic member to provide a repulsive force which causes said detachable object to protract away from said base member.

2. The magnetic support according to claim 1, wherein said first repelling magnetic member, and said second repelling magnetic member are arranged relative to each other to produce an asymmetrical repulsive magnetic force causing said detachable object to protract away from said base member in a preferred direction and having a resistance to deflection from external forces such as, but not limited to gravity, or air current.

3. The magnetic support, according to claim 1, wherein said first repelling magnetic member is not permanently fixed in a position, but may be moved about said base member.

4. The magnetic support, according to claim 1, wherein said first anchoring magnetic unit is not fixed in a position, but may be moved relative to said first repelling magnetic member.

5. The magnetic support, according to claim 1, further comprising a stand having a flexible or articulating arm wherein said base member is attached to said stand by way of said flexible or articulating arm.

6. The magnetic support, according to claim 1, wherein said resting side of said base member is attached to a vertical surface such as, but not limited to a wall, post, or stand.

7. The magnetic support, according to claim 1, wherein said second magnetic anchoring unit is disposed between said proximal end of said detachable object and said second repelling magnetic member.

8. The magnetic support, according to claim 1, further comprising a ferromagnetic unit which is disposed within said base member, and is attached to, or in close proximity to said back polar face of said first repelling magnetic member serving as a flux guide.

9. The magnetic support, according to claim 8, wherein said ferromagnetic unit is also attached to, or in close proximity to said back side of said first magnetic anchoring unit.

10. The magnetic support, according to claim 1, wherein said first repelling magnetic member, and said first magnetic anchoring unit are replaced by a single first magnetic member.

11. The magnetic support, according to claim 9, or 10, wherein said front side of said first magnetic anchoring unit is level with said front polar face of said first repelling magnetic member.

12. The magnetic support, according to claim 1, wherein said front side of said first magnetic anchoring unit is level with said front polar face of said first repelling magnetic member.

13. The magnetic support, according to claim 1, further comprising a ferromagnetic unit which is disposed within said detachable object, and is attached to, or in close proximity to said second polar face of said second repelling magnetic member serving as a flux guide.

14. The magnetic support, according to claim 1, wherein said second repelling magnetic member, and said second magnetic anchoring unit are replaced by a second single magnetic member.

15. The magnetic support, according to claim 1, wherein a plane intersects said point of contact between said base member, and said detachable object creating a separation boundary between said base member, and said detachable object without intersecting said base member, or said detachable object.

16. The magnetic support, according to claim 1, wherein a plane intersects said point of contact between said base member, and said detachable object creating a separation boundary between said base member, and said detachable object without intersecting said base member, or said detachable object excluding said first magnetic anchoring unit, and said second magnetic anchoring unit, and those portions of said base member, and of said detachable object within about a 10 mm radius around said point of contact.

17. The magnetic support, according to claim 1, wherein a plane intersects said point of contact between said base member, and said detachable object and is parallel to said front polar face of said first repelling magnetic member creating a separation boundary between said first repelling magnetic member and said second repelling magnetic member without intersecting said first repelling magnetic member or said second repelling magnetic member.

18. The magnetic support, according to claim 1, wherein a plane intersects said point of contact between said base member, and said detachable object and is parallel to said first polar surface of said second repelling magnetic member creating a separation boundary between said first repelling magnetic member and said second repelling magnetic member without intersecting said first repelling magnetic member or said second repelling magnetic member.

19. The magnetic support, according to claim 1, wherein a plane intersects said point of contact between said base member, and said detachable object creating a separation boundary between said first repelling magnetic member and said second repelling magnetic member without intersecting said first repelling magnetic member or said second repelling magnetic member.

20. The magnetic support, according to claim 1, wherein a any, or all of the magnetic members have been replaced by, or enhanced by electromagnets.
